(19) United States
(12) Patent Application Publication
(10) Pub. No.: US 2007/0106986 A1
(43) Pub. Date: May 10, 2007

(54) Secure virtual-machine monitor

(76) Inventor: William S. Worley JR., Centennial, CO (US)

Correspondence Address: OLYMPIC PATENT WORKS PLLC, P.O. BOX 4277, SEATTLE, WA, 98104, US

(21) Appl. No.: 11/588,117

(22) Filed: Oct. 25, 2006

Related U.S. Application Data
(60) Provisional application No. 60/730,478, filed on Oct. 25, 2005.

(51) Int. Cl. G06F 9/455

(52) U.S. Cl. 718/1

(57) ABSTRACT

Embodiments of the present invention provide secure virtual-machine monitors and secure, base-level operating systems that, in turn, provide secure execution environments for guest operating systems and certain special functions that can interface directly to base-level operating systems. Security is accomplished by employing a small, verifiable component of a secure foundation that executes at highest privilege between the hardware interface and the virtual-machine monitor. The virtual-machine monitor and secure foundation employ virtual-machine-monitor-resident guest-operating-system monitors, memory compartmentalization, and authenticated calls to securely isolate computational entities from one another within the computer system.

### CROSS-REFERENCE TO RELATED APPLICATION

This application claims the benefit of Provisional Application No. 60/730,478, filed Oct. 25, 2005

### TECHNICAL FIELD

The present invention is related to computer architecture and operating systems and, in particular, to a secure, virtual-machine monitor and underlying secure foundation that together provide a secure environment for execution of guest operating systems, as well as a direct interface to the secure foundation for direct execution of certain high-security functions.

### BACKGROUND OF THE INVENTION

Virtual-machine monitors (“VMMs”) provide a virtual-machine interface to the lowest-level, hardware abstraction level of one or more guest operating systems. A VMM is essentially a virtual abstraction layer interposed between the physical hardware resources of a computer system and the operating system or operating systems running on the computer system. A VMM is but one of a large number of abstraction layers within the hardware, firmware, and software that function together to provide the user interfaces and application-program-execution environment familiar to computer users. Even the hardware layer of a modern computer system includes many layers of abstraction. When properly designed, a virtual-abstraction layer shields higher layers from unnecessary details, provides a convenient and useful interface tailored to needs of the higher-level, interfacing level, and prevents higher-level access to lower-level features unnecessary and potentially dangerous to higher layers.

FIG. 1 illustrates the rise and evolution of virtual-machine monitors. FIG. 1 uses a block-diagram-level illustration of the hardware and software layers within a computer system that is used in various forms and subsequent figures. It should be noted, at the onset, that these diagrams are highly simplified, and omit many complexities and interconnections between abstraction layers. Moreover, the relative sizes of the blocks are not reflective of the complexity, code size, or importance of the various abstraction layers and functional layers depicted. Instead, these diagrams are meant only to illustrate the general, relative relationships between various functional and abstraction layers.

In the first computer systems 102, application programs 104 were loaded and run directly above the hardware 106 interface. In these early computer systems, programs were generally written in machine code, and directly entered into memory via control-panel toggle switches or, later, via decks of Hollerith cards.

In order to simplify the programmer's task, and to make better use of expensive hardware resources, a job-control layer 108 was developed for, and added to, a subsequent generation of computer systems 110. The job-control layer provided primitive, sequential scheduling of application programs, primitive I/O interfaces and support, and an assembler to translate assembly code into machine code in order to alleviate the tedium and difficulties attendant with writing machine code. In a subsequent generation of computer systems 112, the job-control layer evolved into a general-purpose operating system 114. The operating system interfaces to the hardware for controlling hardware execution of application programs, and provides an application-program-interface, and application-program-execution environment, for programmers to develop application programs to, and run application programs within. Operating systems provide a full range of services, including I/O services, scheduling, memory management, and other such services.

Initial operating systems were designed to support execution of a single application at a given time. Initially, VMMs 116 were developed as a way to support concurrent execution of multiple operating systems and their applications on a mainframe computer system. The VMM provided a virtual hardware interface to each of multiple, concurrently executing operation systems 118 and 120, each supporting execution of a single application program at a time. Each of the concurrently executing operating systems interfaced to the VMM exactly as they would interface to a bare machine (112 and 114 in FIG. 1). The VMMs essentially partition the hardware sources between the concurrently executing operating systems in a way that the partitioning, and execution of multiple operating systems, is transparent to a given operating system.

In a next generation of computer systems 122, general-purpose, multi-tasking operating systems featuring virtual memory support, time-division multiplexing of processor cycles, and other such features obviated the initial need for VMMs, and VMMs were, for a time, no longer an active topic for research and development. General-purpose operating systems continued to evolve and expand in size, functionality, and complexity, incorporating many new features and functionalities and engulfing features and functionalities previously considered to be within the domain of application programs and other specialized, but separate, computing entities.

More recently, VMMs have again become the target of research and development efforts, and have found many uses in modern computing environments. A new class of VMMs 124 has been developed to support concurrent execution of multiple, guest, general-purpose, multi-tasking operating systems 126 and 128 on modern computer hardware 130. These modern VMMs find use in operating-system development as well as for creating an environment in which complex application programs developed for specific operating systems can be run together on a single hardware platform. Currently, a much more elaborate and capable type of VMM 132 is being developed and deployed to allow for execution of multiple, general-purpose, multi-tasking operating systems 134-136, each supporting multiple, concurrently or simultaneously executing applications 138-147 on top of multiple different hardware platforms 150 and 152.

FIG. 2 illustrates a number of motivations for employing virtual-machine monitors in modern computing environments. A first motivation is to separate, and secure, two applications 202 and 203 concurrently or simultaneously executing, above a single operating system 204, on a hardware platform 206 by introducing a VMM 208 to provide a robust operating-system execution environment to support independent execution of each of the two applications 202 and 203 above separate instances 210 and 212 of the operating system 204. A separation of the application programs may increase security by removing direct, operating-system-provided control and data pathways between the two applications. Moreover, reliability may be increased because failures at the operating system level, or even at the virtual-machine level, may be isolated to impact only a single operating-system instance and application program, rather than impacting all of the application programs running above a single operating system. This motivation is particularly germane to isolation of computationally intense server applications that are prone to security attacks, including domain-name servers and HTTP servers, from other servers and the computational entities that run on a given machine.

A second motivation for using VMMs is to consolidate multiple specialized applications executing on underutilized hardware. As an example, two applications 216 and 218 may each run on two different operating systems (“OSs”) 220 and 222, respectively, above two different hardware platforms 224 and 226. It may be the case that one or both applications are specifically tailored to run above a particular OS that is not ported to one or the other hardware systems. By using a VMM 230, a single hardware platform 232 can support execution of both applications 216 and 218 above their respective operating systems 220 and 222 that run as guest operating systems above the VMM. Thus, rather than supporting two different, potentially underutilized hardware platforms 224 and 226, the computing environment can instead consolidate the applications on a single, well-utilized hardware platform 232.

A third motivation for employing VMMs is to support dynamic and fluid migration of computing tasks among a number of potentially distributed, discrete hardware platforms. For example, in FIG. 2, two applications 240-242 are shown executing above a first operating system 244 and two additional applications 246 and 248 are shown executing above a third operating system 249. A second operating system 250 is not currently executing an application program in FIG. 2. It may be desirable, from the standpoint of the underlying hardware platforms 252-254, to reassign the application programs 240, 242, 246, and 248 to different hardware platforms. For example, the assignment may be made to better match the computational needs of application programs to the computational resources available on hardware platforms. In other cases, migration of application programs to hardware platforms most closely associated with particular special resources accessed by the application programs may result in more efficient execution as well as alleviate network bottlenecks and latencies. Distributed operating systems have been developed to address these needs, but distributed operating systems are often complex, expensive, and unreliable. By using a VMM 256 support for migration of computational entities can be decoupled from complexities of the operating system level, so that operating-system instances, along with their currently executed applications, can be moved between machines reliably and efficiently.

While FIG. 2 illustrates a number of motivations for employing VMMs, many additional motivations are recognized. The VMM may be the better and most economical approach to providing truly secure computing environments on single-processor machines, multi-processor machines, and distributed computer systems. VMMs may also substantially increase the flexibility and options available to computer-system developers and administrators, at minimum cost, to allow computer-system administrators and developers to select the most efficient and economical components needed to meet their goals, rather than being constrained by complex interdependencies between application programs, service programs, operating systems, and hardware platforms.

FIG. 3 illustrates, at a block-diagram level, the VMM virtual abstraction. In FIG. 3, the VMM 302 and 303 is layered above the physical hardware 304 of a computer system. An operating system 306-307 is layered above the VMM, and software libraries 308-310 are layered above the operating system. Finally, an application program 312 is layered above the libraries 308-310, operating system, and a small portion 314 of the hardware platform 304. The hardware platform consists of, at the interface level, a set of privileged instructions 316, a set of unprivileged instructions 318, a register interface to I/O devices 320, and a register-based interface to network devices 322. In general, device drivers, indicated by dashed rectangles 324 and 326, interface to the I/O interface 320 and the network I/O interface 322. In FIG. 3, the device drivers 324 and 326 are shown in dashed lines to indicate that they may reside within the VMM, within the operating system, or both the VMM and operating system. The VMM is designed to protect the privileged instructions 316 and I/O interfaces of the hardware layer from direct access by the operating system 306-307, libraries 308-310, and application program 312. By protecting the privileged instructions from direct access by higher levels, the VMM can ensure that the state of the hardware system, controlled by the privileged instructions, transitions along acceptable and secure state-transition paths. The VMM protects the operating system from itself, from foreign entities introduced into the operating system, and from malicious application programs that might attempt to use operating system services in order to defeat security measures within the operating system and corrupt other application programs or remote computer systems. Because the unprivileged instructions 314 do not affect the core hardware-platform state variables, including translation-look-aside-buffer entries, status registers, and other such state-controlling resources, and because protection of the unprivileged instructions by the VMM would generally introduce unreasonable computational overhead, the unprivileged instructions are directly accessible to the operating system, libraries, and application program. In certain VMM implementations, the VMM includes all of the device drivers needed to interface to the physical hardware. The operating system is modified to call I/O services provided by the VMM, rather than to attempt to directly interface to the hardware I/O interfaces. In other VMM implementations, the VMM uses operating-system device drivers in a controlled and protected fashion.

Because the VMM is introduced between the operating system and the hardware, the VMM can provide a virtual hardware interface, as discussed above, to partition hardware resources among multiple, concurrent or simultaneously executing operating-system instances, and can shield the operating system and higher-level entities from behaviors that would compromise the individual securities of application programs and operating systems and the overall security of the computer system.

Although VMMs are currently being developed to address security, portability, and distributed-computing goals, current virtual-machine monitors are still far from being completely secure. FIG. 4 illustrates many of the different aspects of VMM-based computer systems that remain vulnerable to attack or compromise by malicious or erroneous computational entities. In general, much of the data used and generated by computational entities running on a computer system is stored in mass-storage devices 404. In many computer systems today, this data is poorly protected, and is exposed to access by malicious entities and corruption by erroneous computational entities. In particular, removable mass-storage devices, including READ/WRITE CDs, removable disk and flash memory devices, and other such devices, can be easily disconnected from the computer system 402 and reconnected to another computer system for analysis and modification or remotely accessed through alternative ports. Similarly, the internal memory 406 of a computer system is generally partitioned by the VMM between guest operating systems 408 and 410 and many application programs executing above the guest operating systems 412-416. However, in general, the partitioning is not fully secure, leaving security gaps that allow one operating system to access memory and modify the contents of memory allocated to another operating system, with application programs potentially accessing and modifying memory allocated to operating systems and other application programs. Data streams received through network communications 420 may contain malicious executables or data that can attack any of the software layers of the computer system. While the VMM 422 endeavors to partition hardware resources between guest operating systems and application programs executing above the guest operating systems, VMMs often have security vulnerabilities that allow one guest operating system to glean information from, or even affect operation of, another operating system through VMM-provided services.

For all of the reasons discussed above with reference to FIG. 4, and for many additional reasons, developers, manufacturers, and users of computer systems have all recognized the need for improvements in virtual-machine monitors to increase the overall security of computer systems using the virtual-machine monitors, without correspondingly decreasing the efficiency of execution of guest operating systems and application programs above the virtual-machine monitors and without introducing so much added complexity and code that, like operating systems, the virtual-machine monitors become too complex to be properly designed for secure operation.

### SUMMARY OF THE INVENTION

Embodiments of the present invention provide secure virtual-machine monitors and secure, base-level operating systems that, in turn, provide secure execution environments for guest operating systems and certain special applications that can interface directly to base-level operating systems. Security is accomplished by employing a small, verifiable, secure foundation, only a small part of which executes at highest privilege between the hardware interface and the virtual-machine monitor. The virtual-machine monitor and secure foundation employ virtual-machine-monitor-resident guest-operating-system monitors, memory compartmentalization, and authenticated calls to securely isolate computational entities from one another within the computer system.

### BRIEF DESCRIPTION OF THE DRAWINGS

FIG. 1 illustrates the rise and evolution of virtual-machine monitors.

FIG. 2 illustrates a number of motivations for employing virtual-machine monitors in modern computing environments.

FIG. 3 illustrates, at a block-diagram level, the VMM virtual abstraction.

FIG. 4 illustrates many of the different aspects of VMM-based computer systems that remain vulnerable to attack or compromise by malicious or erroneous computational entities.

FIG. 5 illustrates virtual memory provided by a combined operating-system/hardware system.

FIG. 6 illustrates a virtual-monitor-based approach to supporting multiple, concurrently executing operating systems.

FIG. 7 show the registers within an Itanium processor.

FIGS. 8-11 illustrate the memory and virtual-address-translation architecture of the Itanium computer architecture.

FIGS. 12A-B provide details of the contents of a region register and the contents of a VHPT long-format entry.

FIGS. 13A-B provide additional details about the virtual-memory-to-physical-memory translation caches and the contents of translation-cache entries.

FIG. 14 provides additional details regarding the contents of protection-key registers.

FIG. 15 shows the virtual-address translation mechanism provided by the Itanium architecture, discussed above with reference to FIG. 5.

FIG. 16A illustrates a portion of a computer memory and storage of a portion of an executable program in the portion of computer memory.

FIG. 16B illustrates immediate and register operands in the context of a branch instruction.

FIGS. 17A-D further illustrate Itanium instructions.

FIG. 18 shows a typical medieval castle.

FIG. 19 illustrates the overall strategy and architecture of a secure VMM and underlying secure foundation that represent embodiments of the present invention.

FIGS. 20A-F illustrate the chain of trust inherent in instantiation of components of a VMM-based computer system according to embodiments of the present invention.

FIGS. 21A-B illustrate the call-authentication method used according to embodiments of the present invention to partition secure-foundation and VMM services among higher-level computing entities and to strictly control access to various computational resources, including VMM memory compartments that store critical data used by higher-level entities.

FIGS. 22A-C illustrate, in an alternative fashion, control of memory compartments via the authenticated-call mechanism.

FIG. 23 illustrates one fundamental feature of VMMs that represent embodiments of the present invention.

FIG. 24 illustrates another fundamental feature of virtual-machine monitors that represent embodiments of the present invention.

FIG. 25 illustrates partitioning of computational tasks of a VMM-based computer system among cores of a multi-core processor.

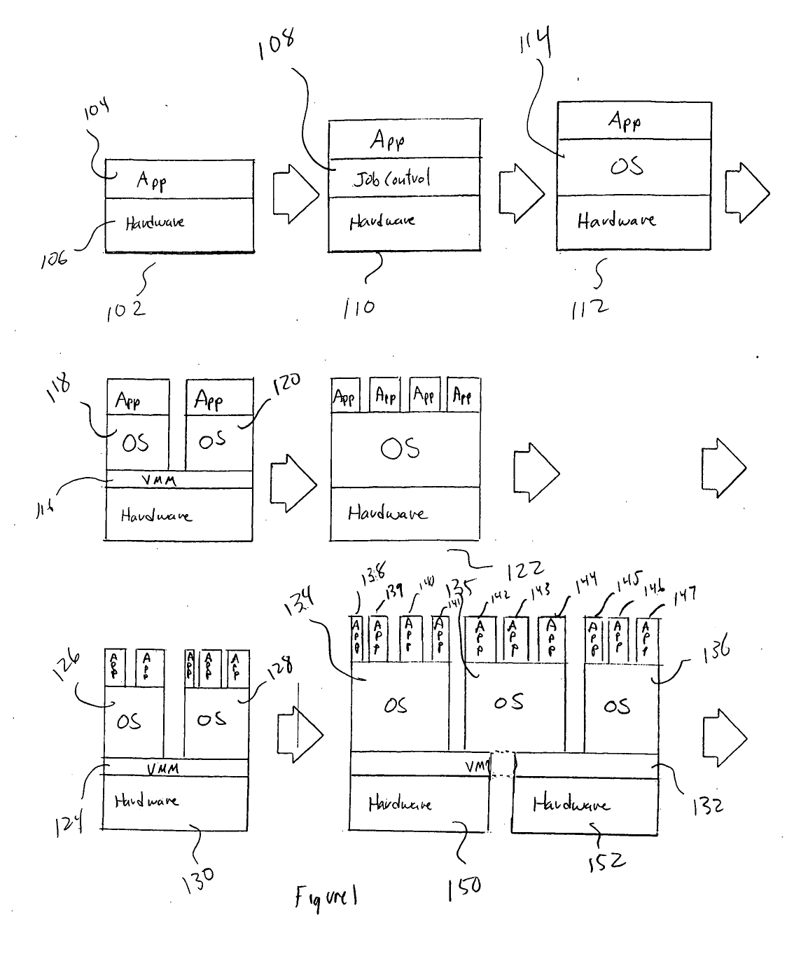

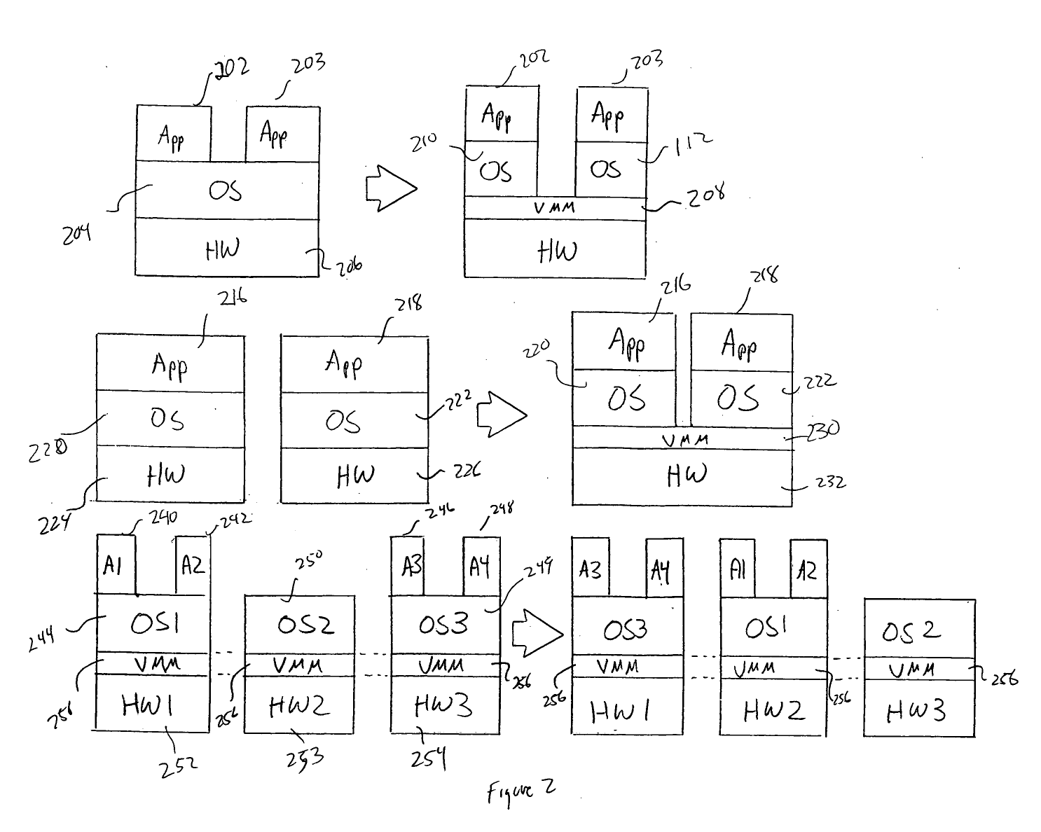

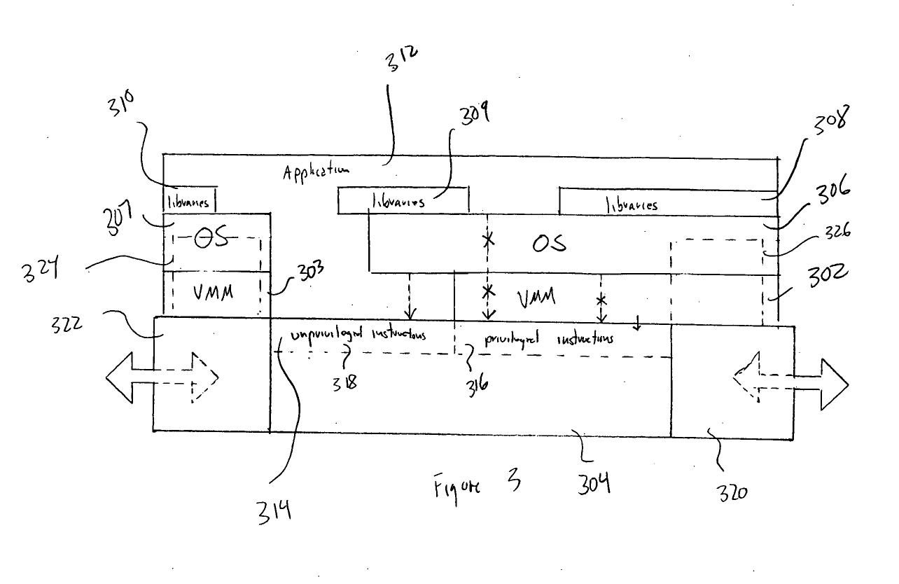

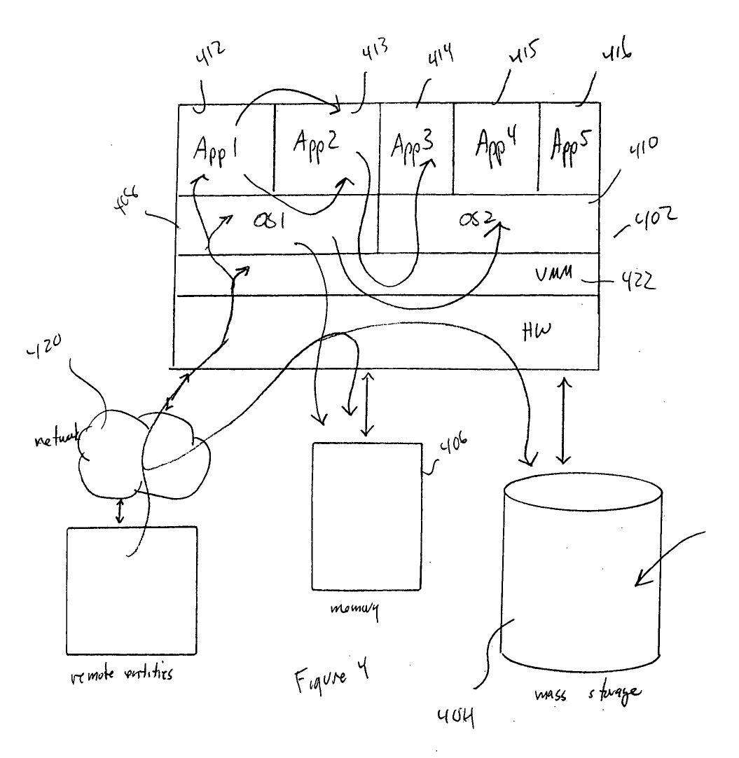

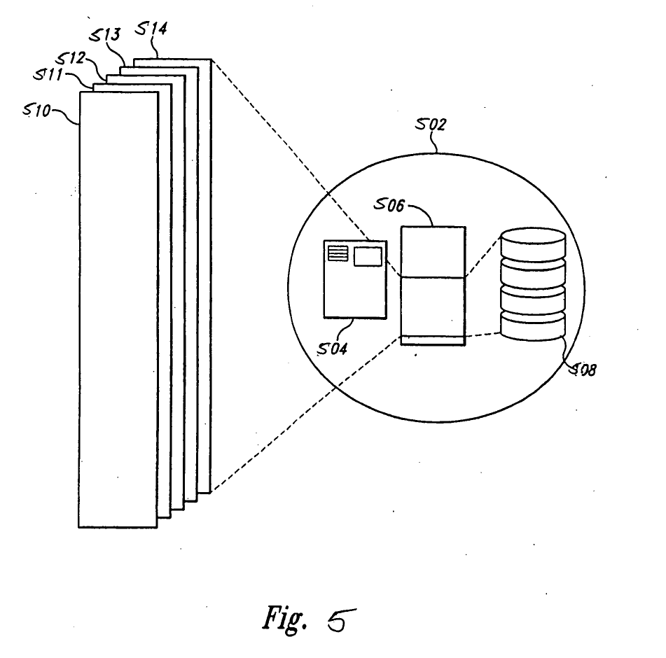

### DETAILED DESCRIPTION OF THE INVENTION

Embodiments of the present invention are directed to secure virtual-machine monitors and to an underlying secure foundation that supports the secure virtual-machine monitor and that can also support direct execution of certain, special applications. Currently, the various embodiments of the present invention are directed for implementation on computer systems employing processors of the Intel Itanium-2® family of processors. In a first subsection, below, the Intel Itanium® and Itanium-2® architecture is described, at a relatively high level. In a second subsection, that follows, embodiments of the present invention are described.

### Intel Itanium Architecture

FIG. 5 illustrates virtual memory provided by a combined operating-system/hardware system. In FIG. 5, the operating system is abstractly represented as a circle 502 enclosing hardware components including a processor 504, physical memory 506, and mass-storage devices 508. FIG. 5 is intended to abstractly represent certain features of the hardware system, or machine, rather than to accurately represent a machine or enumerate the components of a machine. In general, the operating system provides, to each process executing within the execution environment provided by the operating system, a large virtual-memory address space, represented in FIG. 5 by vertical columns external to the operating system, such as vertical column 510. The virtual-memory address space defines a sequence of addressable memory bytes with addresses ranging from 0 to 2⁶⁴−1 for a combined operating-system/hardware system supporting 64-bit addresses. The Itanium virtual address space is up to 85 bits wide, comprising a 61-bit offset and a 24-bit region selector, with a 64-bit address space accessible at any point in time. Depending on the machine and operating system, certain portions of the virtual-memory address space may be inaccessible to a process, and various mechanisms may be used to extend the size of the virtual-memory address space beyond the maximum size addressable by the machine-supported addressing unit. An operating system generally provides a separate virtual-memory address space to each process concurrently executing on top of the operating system, so that, as shown in FIG. 5, the operating system may simultaneously support a number of distinct and separate virtual-memory address spaces 510-514.

A virtual-memory address space is, in many respects, an illusion created and maintained by the operating system. A process or thread executing on the processor 504 can generally access only a portion of physical memory 506. Physical memory may constitute various levels of caching and discrete memory components distributed between the processor and separate memory integrated circuits. The physical memory addressable by an executing process is often smaller than the virtual-memory address space provided to a process by the operating system, and is almost always smaller than the aggregate size of the virtual-memory address spaces simultaneously provided by the operating system to concurrently executing processes. The operating system creates and maintains the illusion of relatively vast virtual-memory address spaces by storing the data, addressed via a virtual-memory address space, on mass-storage devices 508 and rapidly swapping portions of the data, referred to as pages, into and out from physical memory 506 as demanded by virtual-memory accesses made by executing processes. In general, the patterns of access to virtual memory by executing programs are highly localized, so that, at any given instant in time, a program may be reading to, and writing from, only a relatively small number of virtual-memory pages. Thus, only a comparatively small fraction of virtual-memory accesses require swapping of a page from mass-storage devices 508 to physical memory 506.

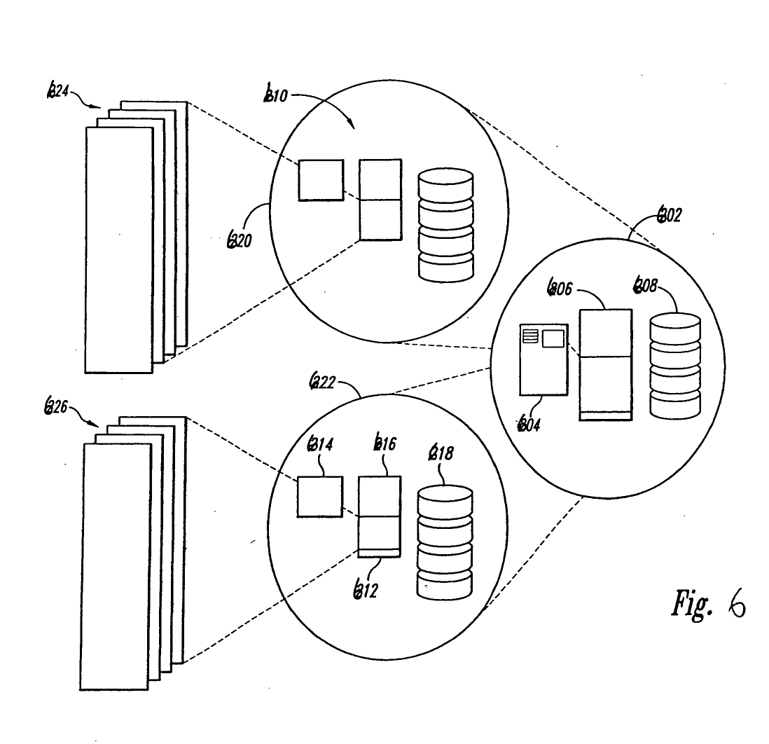

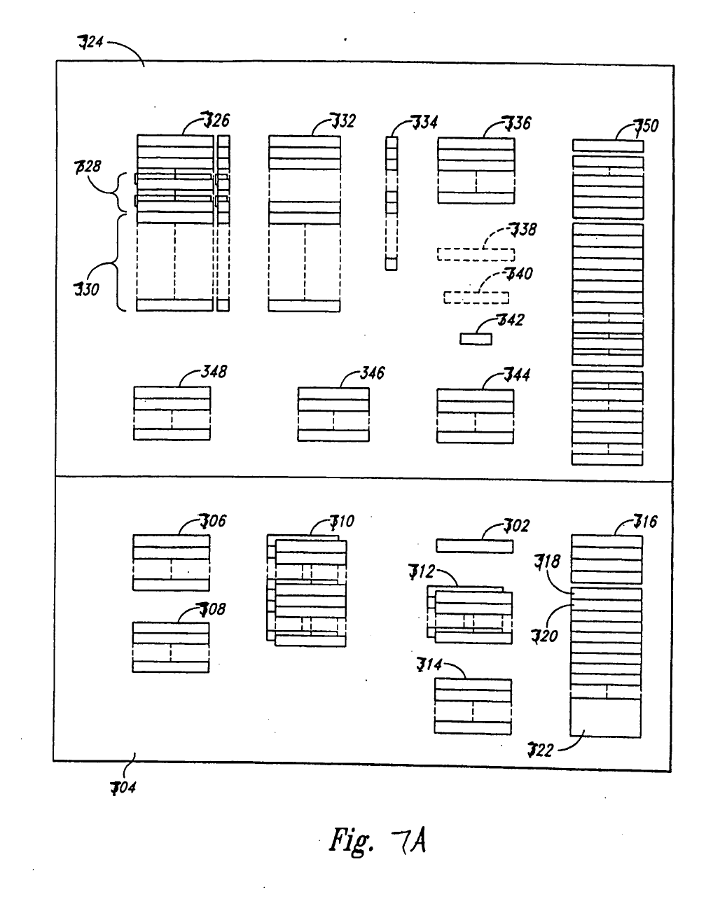

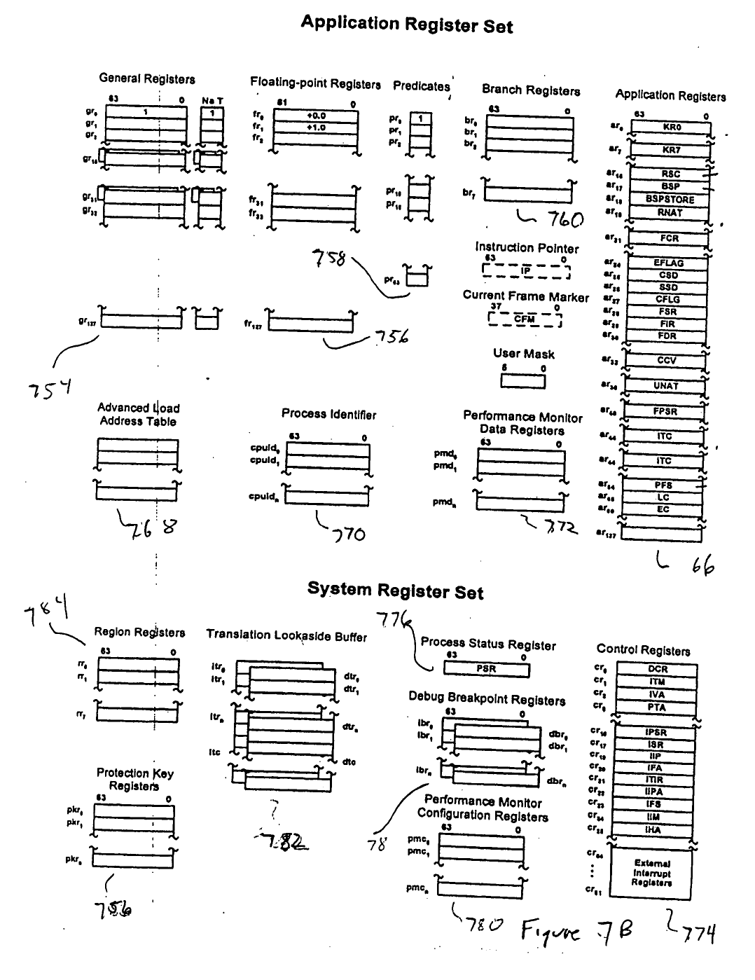

A virtual-machine monitor is a set of routines that lie above the physical machine interface, and below all other software routines and programs that execute on a computer system. A certain type of virtual-machine monitor, also referred to as a “hypervisor” or simply as a “monitor,” provides a virtual-machine interface to each operating system concurrently executing on the computer system. The virtual-machine interface includes those machine features and characteristics expected of a machine by operating systems and other programs that execute on machines. For example, a virtual-machine interface includes a virtualized virtual-memory-system interface. FIG. 6 illustrates a virtual-monitor-based approach to supporting multiple, concurrently executing operating systems. In FIG. 6, a first circle 602 encloses the physical processor 604, physical memory 606, and mass-storage devices 608 of a computer system. The first enclosing circle 602 represents a virtual-machine monitor, a software layer underlying the traditional operating-system software layer of the computer system. The virtual-machine monitor provides virtual-machine interfaces 610 and 612. The virtual machine can be considered to include a virtual processor, virtual physical memory, and virtual mass-storage devices, e.g., 614, 616, 618, respectively. An operating system software layer can be considered to encapsulate each virtual machine, such as operating systems 620 and 622 represented by circles in FIG. 6. In turn, the operating systems each provide a number of guest-virtual-memory address spaces 624 and 626 to processes concurrently executing within the execution environments provided by the operating systems. The virtual-machine monitor may provide multiple virtual processors to guest operating systems, and may provide a different number of virtual processors than the number of physical processors contained in the computer system.

Processors, such as Intel Itanium® processors, built to comply with the Intel® Itanium computer architecture represent one example of a modern computer hardware platform suitable for supporting a monitor-based virtual machine that in turn supports multiple guest-operating-systems, in part by providing a virtual physical memory and virtual-address translation facilities to each guest operating system. FIGS. 7A-B show the registers within an Itanium processor. FIG. 7A is a block diagram showing the registers within the processor. The registers hold values that define the execution state of the processor, and, when saved to memory, capture the machine state of an executing process prior to stopping execution of the process. Restoring certain registers saved in memory allows for resumption of execution of an interrupted process. The register set shown in FIGS. 7A-B is quite complex, and only certain of the registers are described, below.

The process status register (“PSR”) 702 is a 64-bit register that contains control information for the currently executing process. The PSR comprises many bit fields, including a 2-bit field that contains the current privilege level (“CPL”) at which the currently executing process is executing. There are four privilege levels: 0, 1, 2, and 7. The most privileged privilege level is privilege level 0. The least privileged privilege level is privilege level 7. Only processes executing at privilege level 0 are allowed to access and manipulate certain machine resources, including the subset of registers, known as the “system-register set,” shown in FIG. 7A within the lower rectangle 704. One control register, the interruption processor status register (“IPSR”) 718, stores the value of the PSR for the most recently interrupted process. The interruption status register (“ISR”) 720 contains a number of fields that indicate the nature of the interruption that most recently occurred to an interruption handler when the PSR.ic field flips from “1,” at the time of a fault or interrupt, to “0” as the interruption handler is invoked. Other control registers store information related to other events, such as virtual memory address translation information related to a virtual address translation fault, pointers to the last successfully executed instruction bundle, and other such information. Sets of external interrupt control registers 722 are used, in part, to set interrupt vectors. The IHA register stores an indication of a virtual hash page table location at which the virtual-address translation corresponding to a faulting virtual address should be found.

The registers shown in FIG. 7A in the upper rectangular region 724 are known as the “application-register set.” These registers include a set of general registers 726, sixteen of which 728 are banked in order to provide immediate registers for interruption handling code. At least 96 general registers 730 form a general-register stack, portions of which may be automatically stored and retrieved from backing memory to facilitate linkages among calling and called software routines. The application-register set also includes floating point registers 732, predicate registers 734, branch registers 736, an instruction pointer 738, a current frame marker 740, a user mask 742, performance monitor data registers 744, processor identifiers 746, an advanced load address table 748, and a set of specific application registers 750.

FIG. 7B shows another view the registers provided by the Itanium architecture, including the 128 64-bit general purpose registers 754, a set of 128 82-bitfloating point registers 756, a set of 64 predicate registers 758, a set of 64 branch registers 760, a variety of special purpose registers including application registers (“AR”) AR₀ through AR₁₂₇ 766, an advance load address table 768, process-identifier registers 770, performance monitor data registers 772, the set of control registers (“CR”) 774, ranging from CR₀ to CR₈₁, the PSR register 776, break point registers 778, performance monitor configuration registers 780, a translation lookaside buffer 782, region registers 784, and protection key registers 786. Note that particular AR registers and CR registers have acronyms that reflect their use. For example, AR register AR₁₇ 788, the backing-store-pointer register, is associated with the acronym BSP, and this register may be alternatively specified as the BSP register or the AR[BSP] register. In many of the registers, single bits or groups of bits comprise fields containing values with special meanings. For example, the two least significant bits within register AR[RSC] 790 together compose a mode field which controls how aggressively registers are saved and restored by the processor. These two bits can be notationally specified as “AR[RSC].mode.”

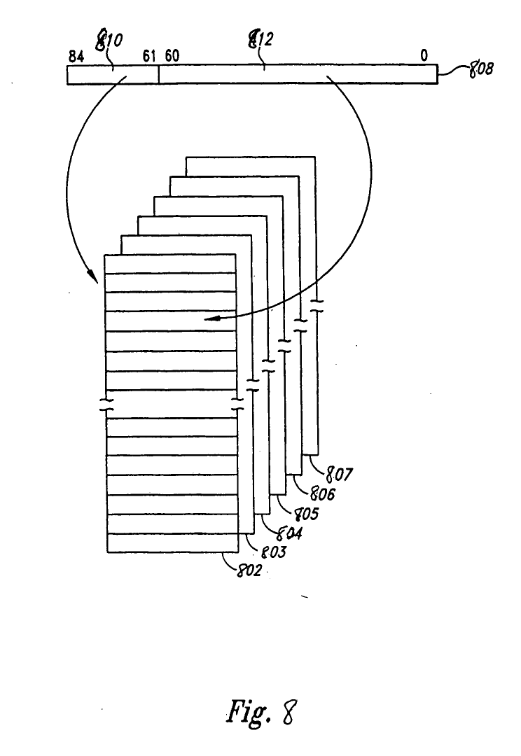

The memory and virtual-address-translation architecture of the Itanium computer architecture is described below, with references to FIGS. 8-11. The virtual address space defined within the Intel Itanium computer architecture includes 2²⁴ regions, such as regions 802-807 shown in FIG. 8, each containing 2⁶¹ bytes that are contiguously addressed by successive virtual memory addresses. Thus, the virtual memory address space can be considered to span a total address space of 2⁸⁵ bytes of memory. An 85-bit virtual memory address 808 can then be considered to comprise a 24-bit region field 810 and a 61-bit address field 812.

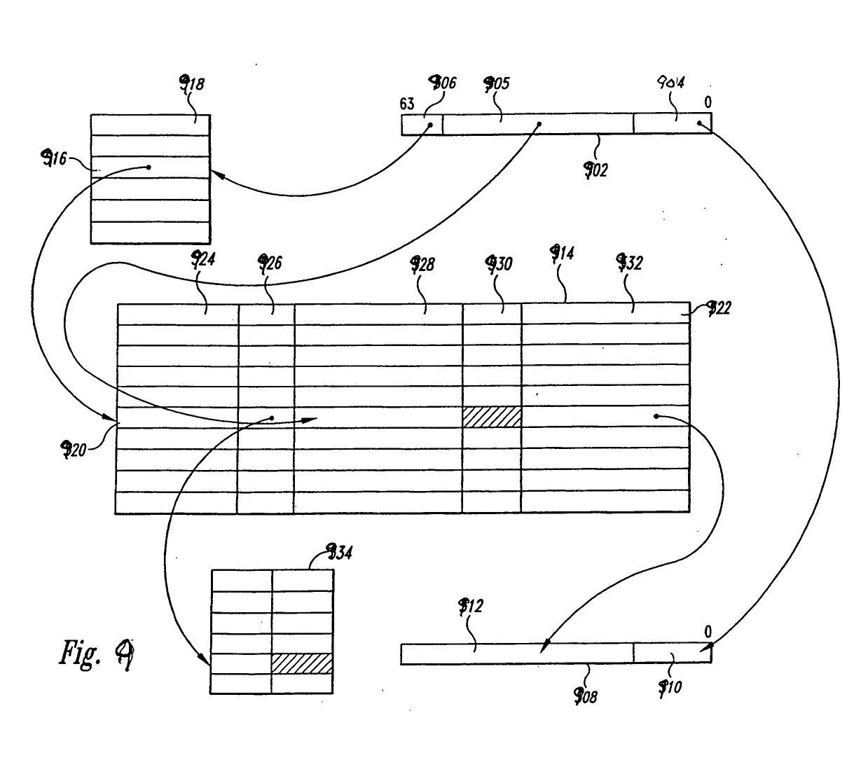

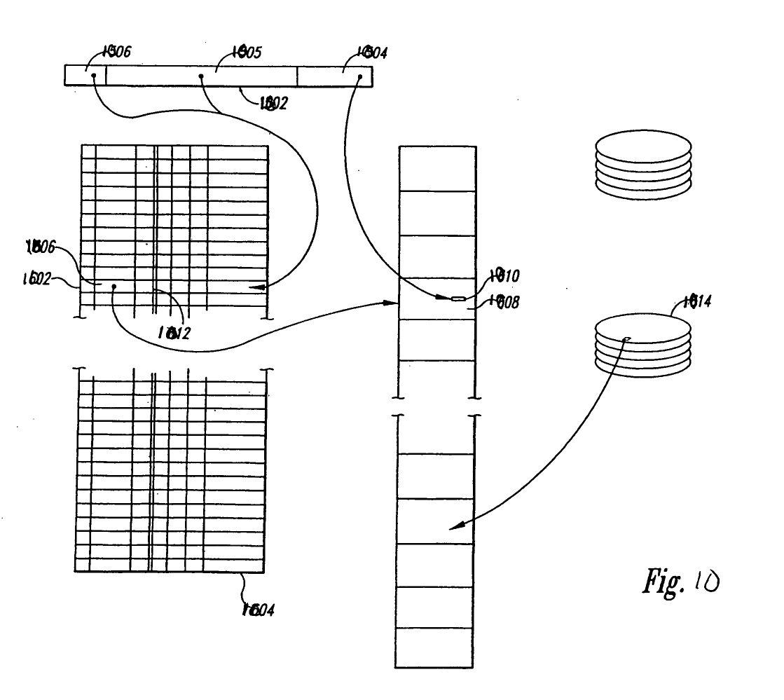

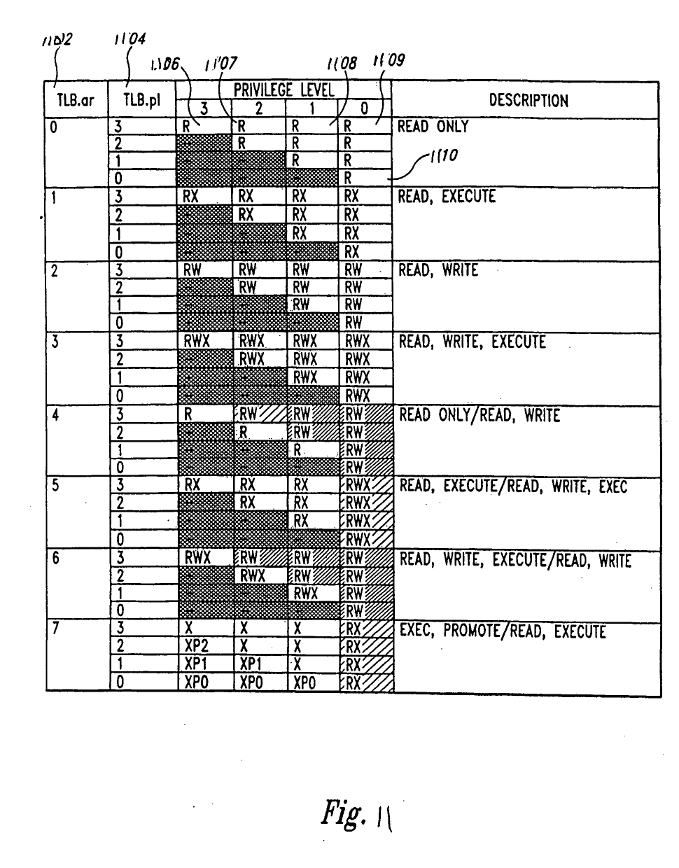

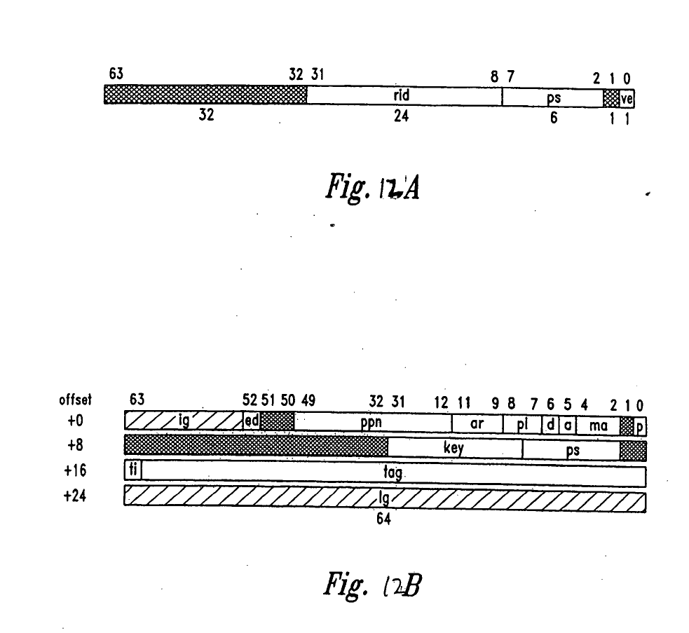

In general, however, virtual memory addresses are encoded as 64-bit quantities. FIG. 9 illustrates translation of a 64-bit virtual memory address into a physical memory address via information stored within region registers, protection key registers, and a translation look-aside register buffer (“TLB”). In the Intel® Itanium architecture, virtual addresses are 64-bit computer words, represented in FIG. 9 by a 64-bit quantity 902 divided into three fields 904-906. The first two fields 904 and 905 have sizes that depend on the size of a memory page, which can be adjusted within a range of memory page sizes. The first field 904 is referred to as the “offset.” The offset is an integer designating a byte within a memory page. If, for example, a memory page contains 4096 bytes, then the offset needs to contain 12 bits to represent the values 0-4095. The second field 905 contains a virtual page address. The virtual page address designates a memory page within a virtual address space that is mapped to physical memory, and further backed up by memory pages stored on mass storage devices, such as disks. The third field 906 is a three-bit field that designates a region register containing the identifier of a region of virtual memory in which the virtual memory page specified by the virtual page address 905 is contained.

One possible virtual-address-translation implementation consistent with the Itanium architecture is next discussed. Translation of the virtual memory address 902 to a physical memory address 908 that includes the same offset 910 as the offset 904 in the virtual memory address, as well as a physical page number 912 that references a page in the physical memory components of the computer system, is carried out by the processor, at times in combination with operating-system-provided services. If a translation from a virtual memory address to a physical memory address is contained within the TLB 914, then the virtual-memory-address-to-physical-memory-address translation can be entirely carried out by the processor without operating system intervention. The processor employs the region register selector field 906 to select a register 916 within a set of region registers 918. The selected region register 916 contains a 24-bit region identifier. The processor uses the region identifier contained in the selected region register and the virtual page address 905 together in a hardware function to select a TLB entry 920 containing a region identifier and virtual memory address that match the region identifier contained in the selected region register 916 and the virtual page address 905. Each TLB entry, such as TLB entry 922, contains fields that include a region identifier 924, a protection key associated with the memory page described by the TLB entry 926, a virtual page address 928, privilege and access mode fields that together compose an access rights field 930, and a physical memory page address 932.

If a valid entry in the TLB, with present bit=1, can be found that contains the region identifier contained within the region register specified by the region register selector field of the virtual memory address, and that entry contains the virtual-page address specified within the virtual memory address, then the processor determines whether the virtual-memory page described by the virtual-memory address can be accessed by the currently executing process. The currently executing process may access the memory page if the access rights within the TLB entry allow the memory page to be accessed by the currently executing process and if the protection key within the TLB entry can be found within the protection key registers 934 in association with an access mode that allows the currently executing process access to the memory page. Protection-key matching is required only when the PSR.pk field of the PSR register is set. The access rights contained within a TLB entry include a 3-bit access mode field that indicates one, or a combination of, read, write, and execute privileges, and a 2-bit privilege level field that specifies the privilege level needed by an accessing process. Each protection key register contains a protection key of up to 24 bits in length associated with an access mode field specifying allowed read, write, and execute access modes and a valid bit indicating whether or not the protection key register is currently valid. Thus, in order to access a memory page described by a TLB entry, the accessing process needs to access the page in a manner compatible with the access mode associated with a valid protection key within the protection key registers and associated with the memory page in the TLB entry, and needs to be executing at a privilege level compatible with the privilege level associated with the memory page within the TLB entry.

If an entry is not found within the TLB with a region identifier and a virtual page address equal to the virtual page address within the virtual memory address and a region identifier selected by the region register selection field of a virtual memory address, then a TLB miss occurs and hardware may attempt to locate the correct TLB entry from an architected mapping control table, called the virtual hash page table (“VHPT”), located in protected memory, using a hardware-provided VHPT walker. If the hardware is unable to locate the correct TLB entry from the VHPT, a TLB-miss fault occurs and a kernel or operating system is invoked in order to find the specified memory page within physical memory or, if necessary, load the specified memory page from an external device into physical memory, and then insert the proper translation as an entry into the VHPT and TLB. If, upon attempting to translate a virtual memory address to a physical memory address, the kernel or operating system does not find a valid protection key within the protection key registers 934, if the attempted access by the currently executing process is not compatible with the access mode in the TLB entry or the read/write/execute bits within the protection key in the protection key register, or if the privilege level at which the currently executing process executes is less privileged than the privilege level needed by the TLB entry, then a fault occurs that is handled by a processor dispatch of execution to operating system code.

FIG. 10 shows one form of a data structure employed by an operating system to find a memory page in physical memory corresponding to a virtual memory address. The virtual memory address 902 is shown in FIG. 10 with the same fields and numerical labels as in FIG. 9. The operating system employs the region selector field 906 and the virtual page address 905 to select an entry 1002 within a virtual page table 1004. The virtual page table entry 1002 includes a physical page address 1006 that references a page 1008 in physical memory. The offset 904 of the virtual memory address is used to select the appropriate byte location 1010 in the virtual memory page 1008. The virtual page table 1002 includes a bit field 1012 indicating whether or not the physical address is valid. If the physical address is not valid, then the operating system commonly selects a memory page within physical memory to contain the memory page, and retrieves the contents of the memory page from an external storage device, such as a disk drive 1014. The virtual page table entry 1002 contains additional fields from which the information needed for a TLB entry can be retrieved. Once the operating system successfully maps the virtual memory address into a physical memory address, that mapping is entered into the virtual page table entry and, formatted as a TLB entry, is inserted into the TLB.

FIG. 11 shows the access rights encoding used in a TLB entry. Access rights comprise a 3-bit TLB.ar mode field 1102 that specifies read, write, execute, and combination access rights, and a 2-bit TLB.pl privilege level field 1104 that specifies the privilege level associated with a memory page. In FIG. 11, the access rights for each possible value contained within the TLB.ar and TLB.pl fields are shown. Note that the access rights depend on the privilege level at which a current process executes. Thus, for example, a memory page specified with a TLB entry with TLB.ar equal to 0 and TLB.pl equal to 3 can be accessed for reading by processes running at any privilege level, shown in FIG. 11 by the letter “R” in the column corresponding to each privilege level 1106-1109, while a memory page described by a TLB entry with TLB.ar equal to 0 and TLB.pl equal to 0 can be accessed by reading only by a process running at privilege level 0, as indicated in FIG. 11 by the letter “R” 1110 under the column corresponding to privilege level 0. The access rights described in FIG. 11 nest by privilege level according to the previous discussion with reference to FIG. 4. In general, a process running at a particular privilege level may access a memory page associated with that privilege level and all less privileged privilege levels. Using only the access rights contained in a TLB entry, it is not possible to create a memory region accessible to a process running at level 3 and the kernel running at level 0, but not accessible to an operating system running at privilege level 2. Any memory page accessible to a process running at privilege level 3 is also accessible to an operating system executing at privilege level 2.

FIGS. 12A-B provide details of the contents of a region register and the contents of a VHPT long-format entry, respectively. As shown in FIG. 12A, a region register includes the following fields: (1) “ve,” a 1-bit Boolean field indicating whether or not the VHPT walker is enabled; (2) “ps,” a 6-bit field indicating a preferred page size for the region, where the preferred page size is 2^{ps}; and (3) “RID,” a 24-bit region identifier. A VHPT long-format entry, as shown in FIG. 12B, includes the following fields: (1) “p,” a 1-bit Boolean field indicating whether or not the corresponding page is resident in physical memory and other fields in the entry contain meaningful information; (2) “ma,” a 3-bit field, called “memory attribute,” which describes caching, coherency, write-policy, and speculative characteristics of the mapped physical page; (3) “a,” a 1-bit field that, when zero, causes references to the corresponding page to generate access faults; (4). “d,” a 1-bit Boolean field that specifies generation of dirty-bit faults upon store or semaphore references to the corresponding page; (5) “pl,” a 2-bit field indicating the privilege level for the corresponding page; (6) “ar,” a 3-bit access-rights field that includes the read, write, and execute permissions for the page; (7) “ppn,” a 38-bit field that stores the most significant bits to the mapped physical address; (8) “ed,” a 1-bit Boolean field whose value contributes to determining whether to defer a speculative load instruction; (9) “ps,” a 6-bit field indicating the page size for virtual-memory mapping; (10) “key,” a protection key associated with the corresponding virtual page; (11) “tag,” a translation tag used for hash-base searching of the VHPT; and (12) “ti,” a 1-bit Boolean field indicating whether or not the translation tag is valid.

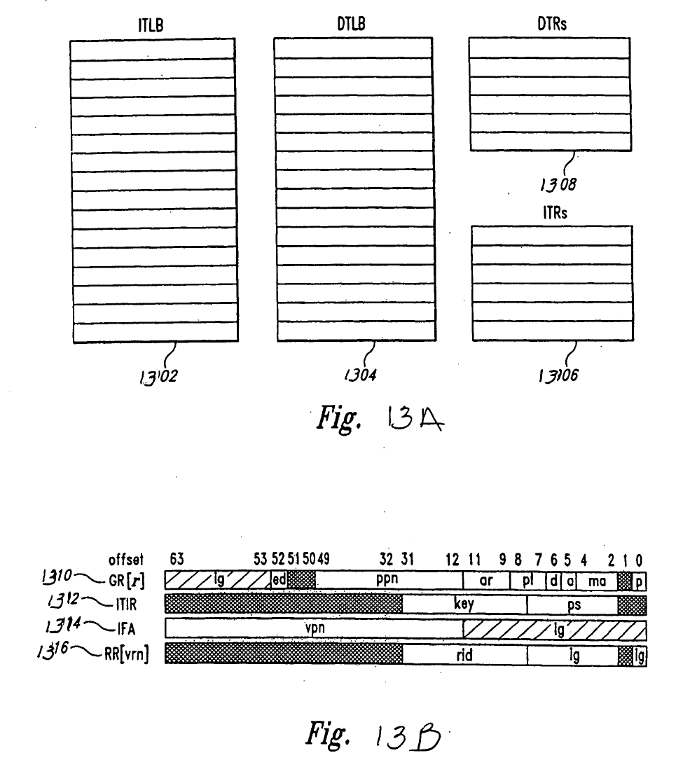

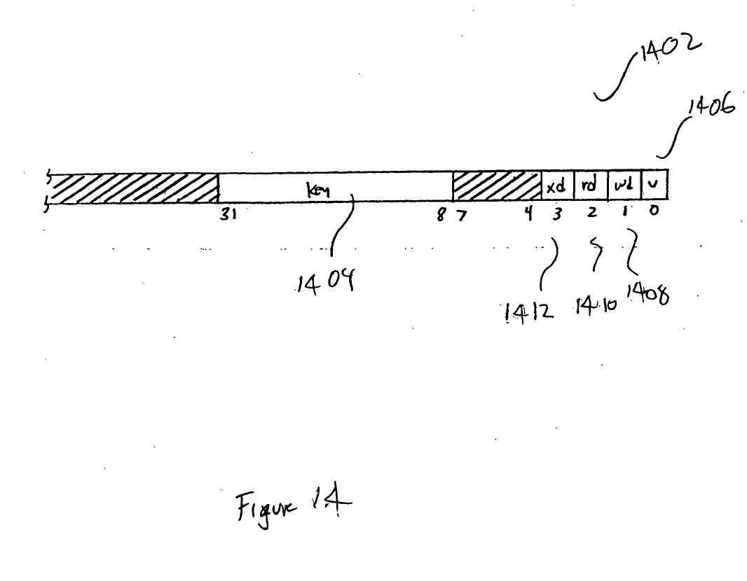

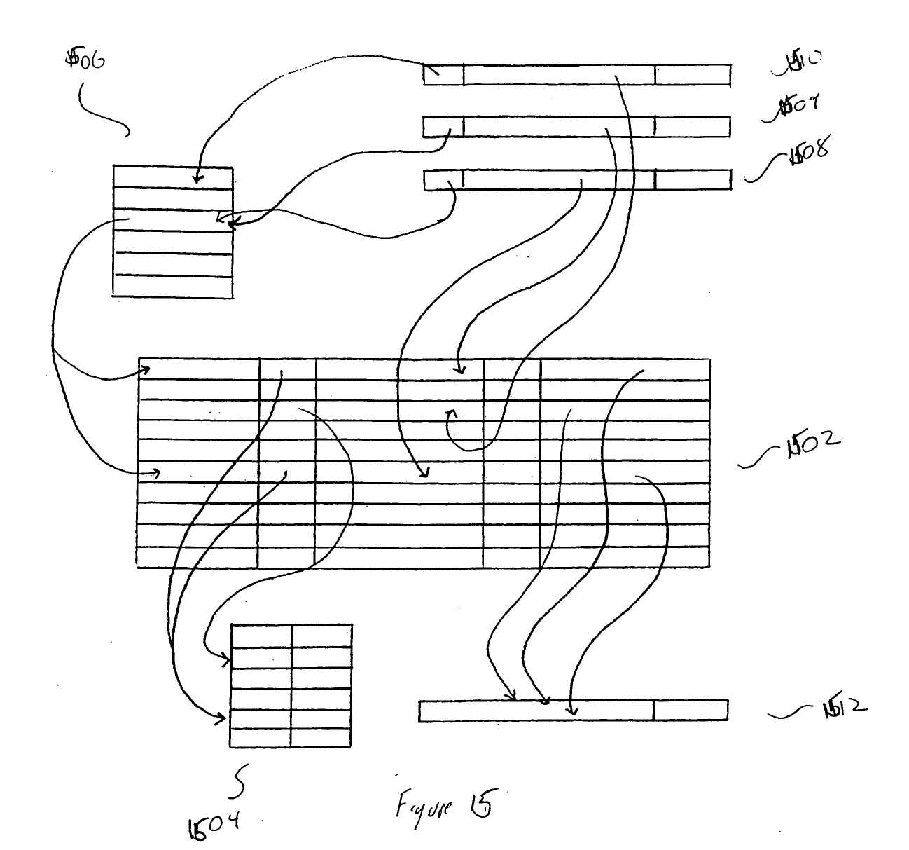

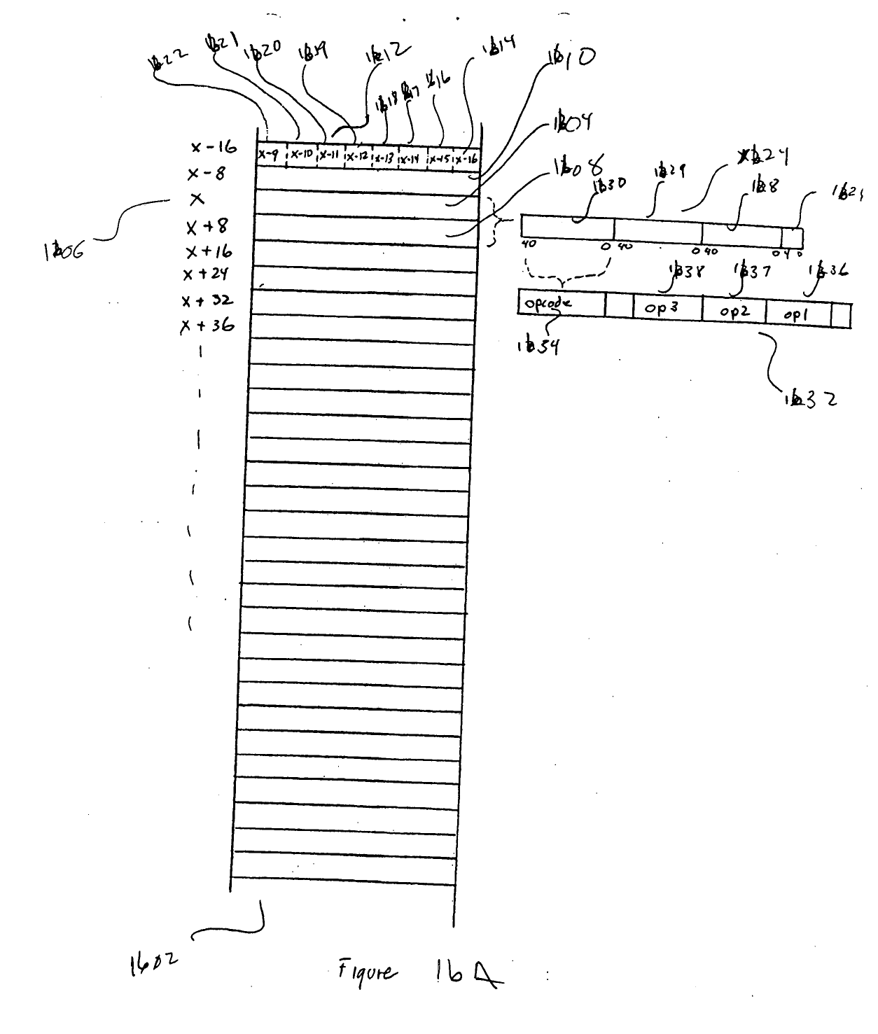

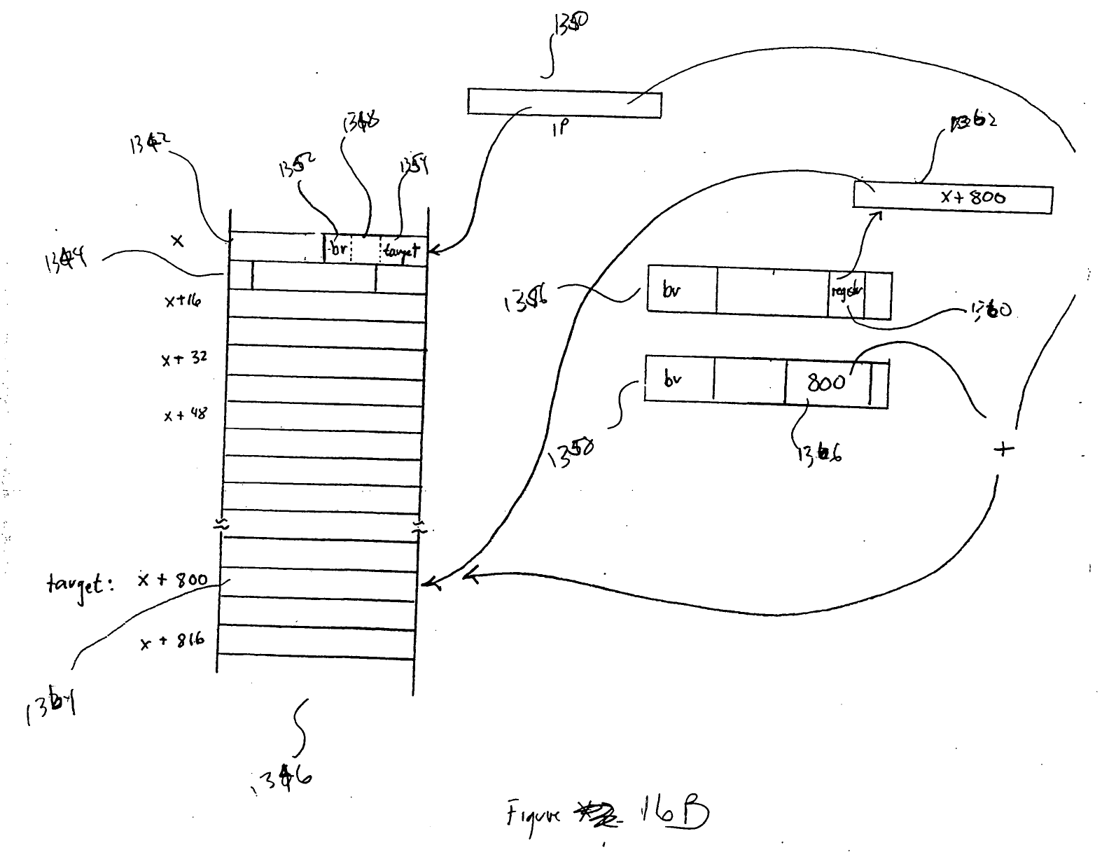

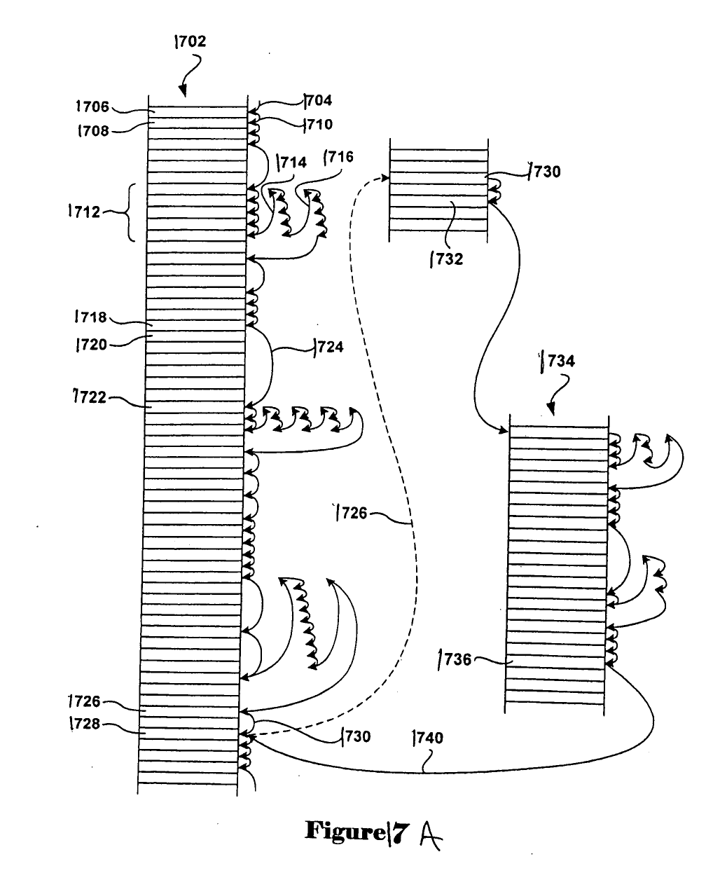

FIGS. 13A-B provide additional details about the virtual-memory-to-physical-memory translation caches and the contents of translation-cache entries. The Itanium provides four translation structures, as shown in FIG. 13A. These include an instruction TLB (“ITLB”), a data TLB (“DTLB”) 1304, a set of instruction translation registers (“ITRs”) 1306, and a set of data translation registers (“DTRs”) 1308. The four translation structures are together referred to as the “TLB.” Entries are placed into the ITLB, DTLB, ITRs, and DTRs by using the privileged instructions itc.i, itc.d, itr.i, and itr.d, respectively. As discussed above, the ITLB and DTLB serve as a first cache for virtual-memory-to-physical-memory translations.

FIG. 13B shows the contents of registers used to insert translation-cache entries into the TLB using the above-described privileged instructions. The contents of four different registers are employed: (1) a general register 1310 specified as an operand to the privileged instruction, the interruption TLB insertion register (“ITIR”) 1312, the interruption faulting address register (“IFA”) 1314, and the contents of the region register 1316 selected by the most significant 3 bits of the IFA register 1314. Many of the fields shown in FIG. 13B are identical to the fields in the VHPT long-format entry, shown in FIG. 12B, and are not again described, in the interest of brevity. The field “vpn” in the IFA register contains the most significant bits of a virtual-memory address. In both a VHPT entry and a translation-cache entry, the most significant bits of a physical page address and virtual-memory-page address (with page-offset bits assumed to be 0) represent the address of a first byte of a physical page and virtual-memory page, respectively. Thus, VHPT entries and TLB entries are referred to as corresponding both to virtual-memory addresses and to virtual-memory pages. The unspecified, least-significant bits of a physical-memory address or virtual-memory address an offset, in bytes, within the physical memory or virtual memory page specified by the most significant bits.

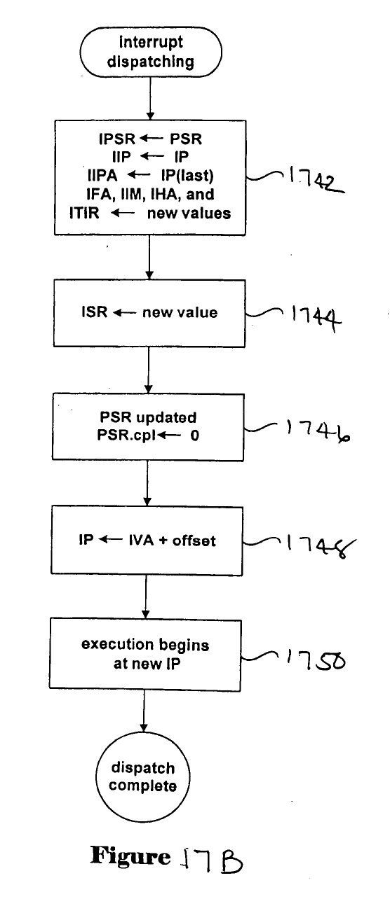

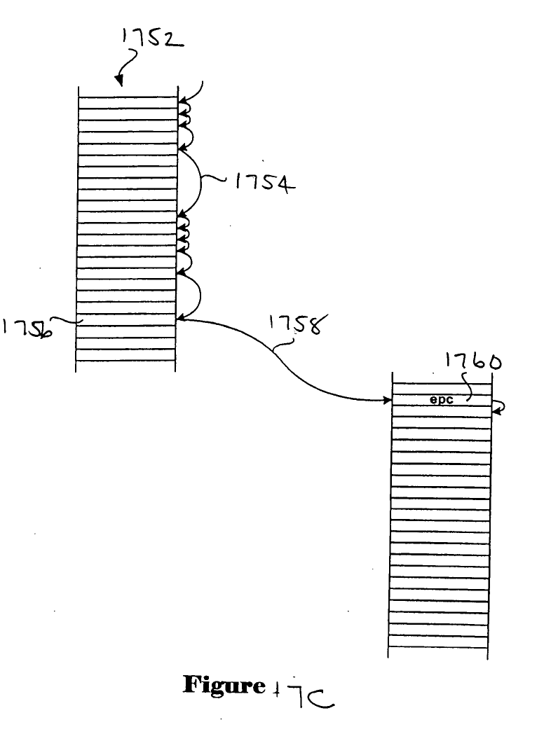

FIG. 14 provides additional details regarding the contents of protection-key registers. The format for a protection-key register 1402 includes a 24-bit key field 1404 and four different single-bit fields that include: (1) a valid bit 1406, which indicates whether or not the protection-key register contains valid contents and is therefore employed by the processor during virtual-address translation; (2) a write-disable bit 1408, which, when set, results in write access denied to pages, the translations for which include the protection key contained in the protection-key field 1404; (3) a read-disable bit, which, when set, disables read access to pages, the translations for which contain the key contained in the key field 1404; and (4) an execute-disable bit 1412, which, when set, prevents execute access to pages, the translations for which contain the key contained in the key field 1404. The read-disable, write-disable, and execute-disable bits in protection key registers provide an additional mechanism to control access to pages, on a key-domain basis rather than on a per-page-access-rights basis.

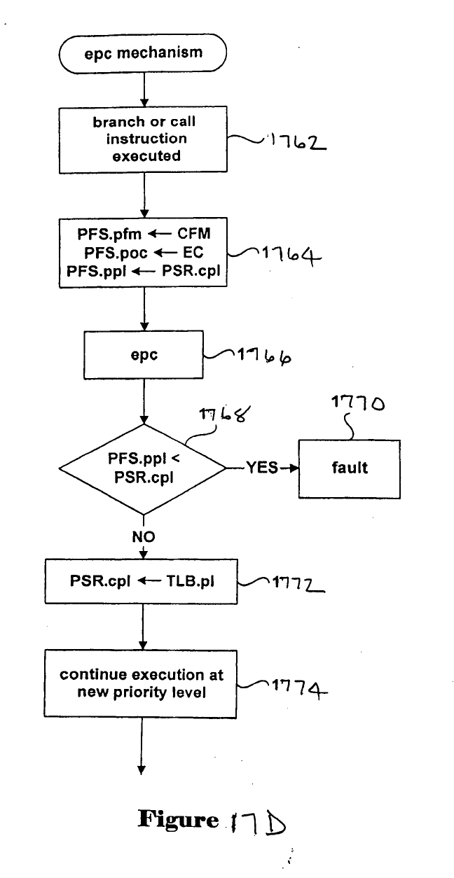

FIG. 15 shows the virtual-address translation mechanism provided by the Itanium architecture, discussed above with reference to FIG. 5. FIG. 15 again shows the translation lookaside buffer 1502, protection-key registers 1504, the region registers 1506, three different virtual addresses 1508-1510, and a physical address 1512 to which all three virtual addresses 1508-1510 translate. When more than one virtual address, such as virtual addresses 1508-1510, translates to a single physical address, such as physical address 1512, the virtual addresses are virtual-address aliases of one another. The Itanium architecture, and many other modern computer architectures, support virtual-address aliasing. Guest operating systems may assume virtual-address-aliasing support, and may employ virtual-address aliasing for various different reasons. Therefore, a virtual-machine monitor providing a virtual-machine interface to guest operating systems needs also to support virtual-address aliasing in a reasonably efficient manner.

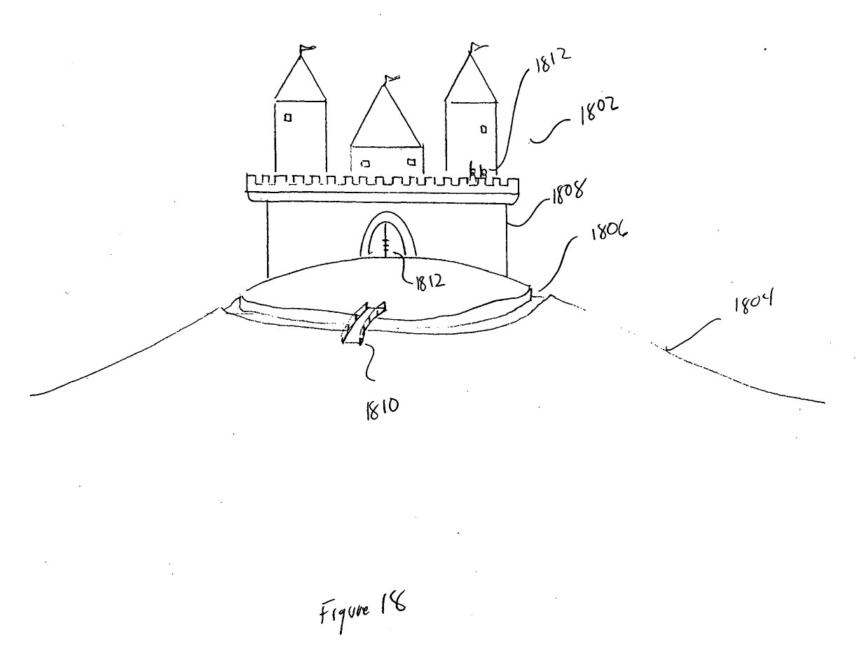

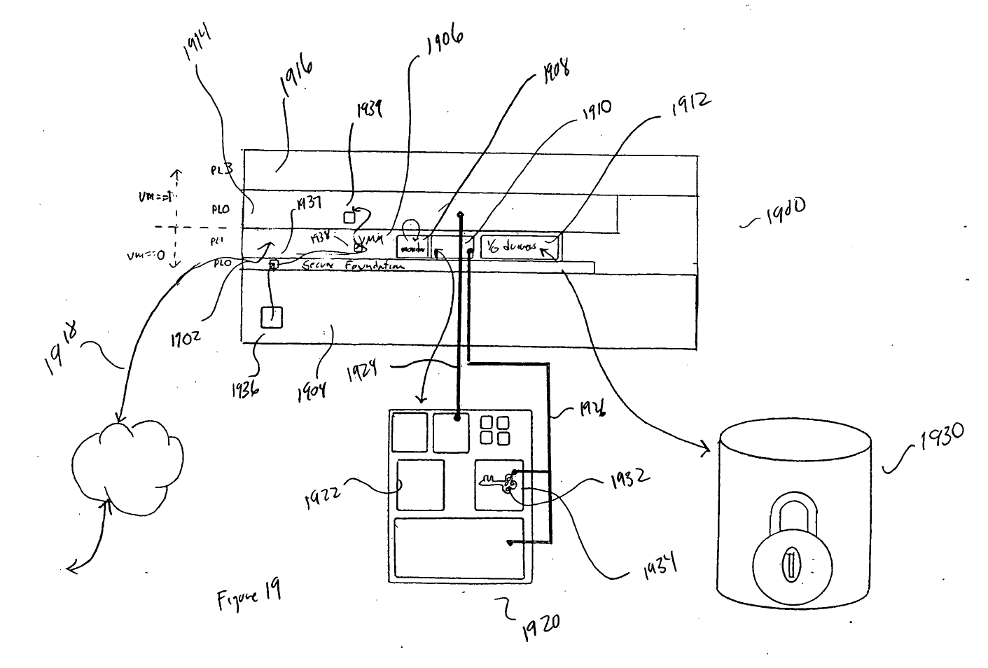

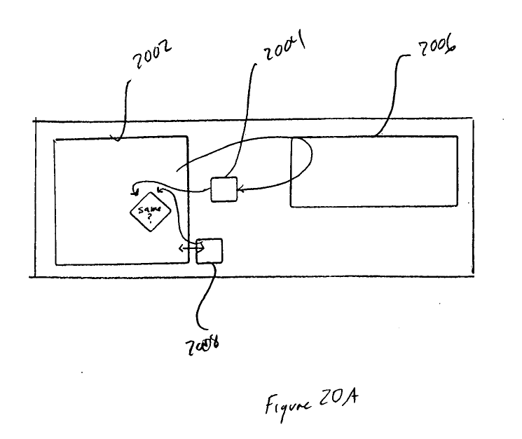

FIG. 16A illustrates a portion of a computer memory and storage of a portion of an executable program in the portion of computer memory. The memory layout and executable-code formatting shown in FIG. 16 is that of the Intel® Itanium architecture. Different types of computers, implemented according to different types of computer architectures, employ different memory and executable-code conventions. However, the principles illustrated for the Itanium-architecture memory and executable-code conventions are general, and apply over a broad range of different types of computers and computer architectures. The computer memory, represented in FIG. 16A by a column 1602 of 64-bit memory words, can be considered to be a very long, ordered sequence of computer words, each word having a distinct address. In general, a computer architecture specifies a natural word size, in the case of Itanium architecture, 64 bits or eight bytes. Different computer architectures and types of computers specify different natural word lengths. For example, in current personal computers (“PCs”), the natural word length is generally 32 bits or four bytes. Different computer architectures and types of computers use different granularities of addressability. In the Itanium architecture, the granularity of addressability is configurable over a range of granularities. For purposes of discussing the present invention, it is assumed that the granularity of addressability is a single byte. The eight bytes within a particular 64-bit natural word in memory are ordered sequentially from a lowest-addressed byte to a highest-addressed byte. Similarly, the bits within each byte, and the bits within an entire word, are also ordered from a least-significant bit to a most-significant bit.

In FIG. 16A, an arbitrarily selected 64-bit word 1604 is assigned, for descriptive purposes, the arbitrary address “X” 1606. In general, memory-word addresses are of length 64 bits, so that each natural computer word can store a single address. The address “X” is the byte address of the least significant byte, or lowest-addressed byte, in the 64-bit computer word 1604. The address of the next computer word 1608 in memory is therefore “X+8,” and the address of the previous word 1610 is “X−8.” The individual bytes within the 64-bit word 1612 at address “X−16” are explicitly shown in FIG. 16, labeled with their byte addresses. The first, lowest-addressed byte 1614 is shown in FIG. 16 with address “X−16,” and the next, successive, higher-addressed bytes 1616-1622 appear, to the left of the lowest-addressed byte 1614 within computer word 1612. The memory layout and addressing conventions illustrated in FIG. 16A apply both to memory that stores executable code as well as memory that stores data. Whether the contents of a memory page are executable or data may be fully or partially determined by the access rights associated with the page, and if not fully determined by the access rights, are ultimately determined by whether or not a stored program attempts to execute what the stored program considers to be instructions within the page.

In the Intel® Itanium architecture, computer instructions are stored in 168-bit bundles. Each 128-bit, or 16-byte, instruction bundle includes three instructions. For example, in FIG. 16, the two, adjacent computer words at addresses “X” and “X+8” 1604 and 1608 together store a single instruction bundle 1624. The instruction bundle 1624 includes a first, five-bit field 1626 that encodes a value that directs the instruction bundle to a particular type of instruction-execution subunit within an Itanium processor. The instruction bundle 1624 additionally contains three instructions 1628-1630, each of length 41 bits. Each instruction, in turn, contains a number of different fields. In FIG. 16A, an expanded view of the last instruction 1630 in instruction bundle 1624 is shown 1632 below the instruction bundle 1624. The formats for instructions vary significantly from instruction to instruction. However, in general, an instruction contains an op code 1634, and most instructions include operands, or arguments. For example, instruction 1632 in FIG. 16A includes three operands 1636-1638. In memory containing a stored program, each successive pair of 64-bit words contains a next instruction bundle. In older computer architectures, instructions are executed in the order in which they are stored in memory. The Itanium architecture, like many modern processor architectures, is somewhat more complex, and features massive pipelining and parallel execution of as many as six instructions. However, for the purposes of describing the present invention, a stored program can be thought of as a sequence of successively stored instruction bundles within memory that are more or less sequentially executed in the order that they are stored, from lower addresses to higher addresses in memory. It should also be appreciated that, without knowing the access rights associated with a memory page containing a particular computer word, or knowing whether a particular computer word will be attempted to be executed by a program, it is impossible to determine, based on the contents of the computer word alone, whether the computer word represents stored data or one word of a two-word instruction bundle. In fact, the same memory word may be, in certain cases, treated as data, and, in other cases, executed as a portion of an instruction bundle.

FIG. 16B illustrates immediate and register operands in the context of a branch instruction. As shown in FIG. 16B, the 64-bit words 1642 and 1644 of a portion of memory 1646, at addresses “X” and “X+16,” contain a three-instruction instruction bundle, the second instruction of which, 1648, is a branch instruction. A branch instruction is used to alter the contents of the IP register 1650 to contain the address of an instruction bundle other than the instruction bundle that follows the currently executing instruction bundle, thereby affecting a machine-level goto operation. As shown in FIG. 16B, the branch instruction includes a numeric op code 1652 that specifies that the instruction is a branch instruction, as well as a single operand 1654 that specifies the target instruction bundle for the branch operation, or the destination instruction of the goto operation effected by the branch instruction. The target operand can be specified in several different ways in different subtypes of the branch instruction. In FIG. 16B, an indirect branch instruction 1656 and an IP-relative branch instruction 1658 are illustrated. The target operand of the indirect branch instruction 1656 is a seven-bit field within the branch instruction that numerically specifies one of the 8 branch registers. For example, in FIG. 16, the branch-register field 1660 specifies a particular branch register 1662. If the branch instruction specifies a goto to a target instruction 1624 at address “X+800,” then the branch register 1622 specified by the register operand 1660 of the indirection branch instruction 1656 contains the address “X+800.” An indirection branch instruction 1656 can therefore transfer execution control to any 64-bit address accessible to the currently executing program. The IP-relative branch instruction 1658 has a target operand field 1666 that contains an offset from the address of the branch instruction to the target instruction to which execution is transferred by the branch instruction. Thus, for example, in FIG. 16B, the target operand 1666 includes the numeric value “800,” which is added to the contents of the IP register 1650 during execution of the IP-relative branch instruction 1658 in order to load the IP register with the address “X+800” of the target instruction 1664. The indirect branch instruction 1656 therefore includes a register operand, the most general type of operand for a computer instruction, while the IP-relative branch instruction 1658 includes an immediate operand, which, in the case of the IP-relative branch instruction, numerically encodes a value used during execution of the instruction. Note, because the immediate-operand, target field 1666 of the IP-relative branch instruction has a length, in bits, significantly shorter than the 64-bit natural word size, the IP-relative branch instruction can transfer execution control to other instructions only within a limited range of instructions preceding and following the branch instruction.

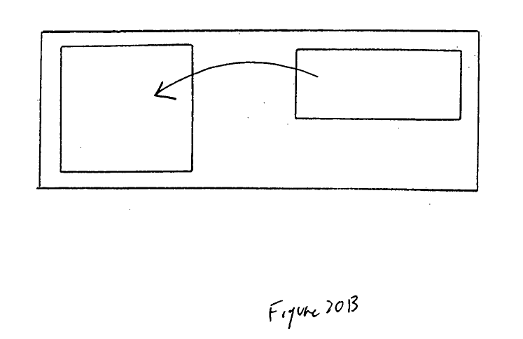

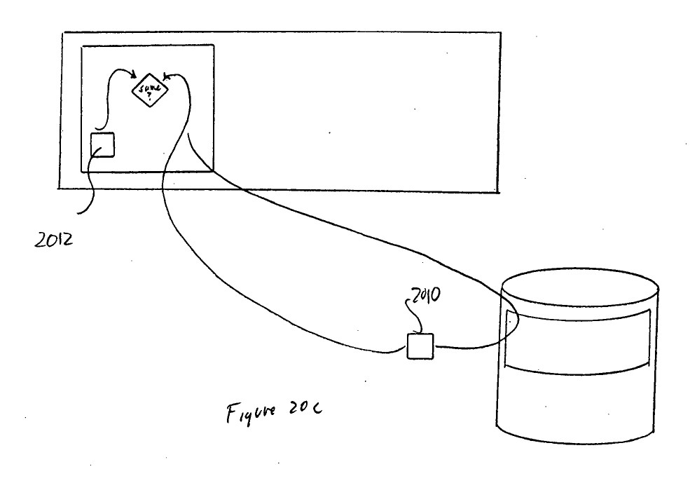

In FIG. 17A, instructions are shown in a sequence in which they are stored in memory. There is a first contiguous sequence of instructions 1702 being executed by the processor, as indicated by the arrows, such as arrow 1704, to the side of the contiguous set of instructions. Thus, the instruction 1706 was first executed, as indicated by arrow 1704, followed by instruction 1708, as indicated by arrow 1710. Various sets of instructions, such as a set of instructions 1712, are repeatedly executed in a loop, as indicated by the backward-pointing arrows 1714 and 1716 in the case of the repeatedly executed set of instructions 1712. In general, instructions are executed in order, except when a branch-type instruction directs execution to an instruction not following the branch instruction, such as a branch instruction 1718 directing execution not to the subsequent instruction 1720 but to the instruction 1722, as indicated by arrow 1724. Occasionally, for one of a variety of reasons, the normal execution thread, as determined by the order of instructions in memory and by the instructions themselves, such as branch instructions, is interrupted, as indicated by the dashed arrow 1726 in FIG. 17A. Instruction 1726 executed and directed execution to instruction 1728, as indicated by arrow 1730. However, due to a trap arising from execution of instruction 1726 or due to a fault or external interrupt arising from an attempt to execute instruction 1728, the flow of instruction execution is interrupted, and instruction execution is directed to an interruption vector having, as its first instruction, instruction 1730. As shown in FIG. 17A, the interruption vector may contain a branch instruction 1732 that directs subsequent instruction execution to an interruption handler routine, indicated in FIG. 17 by a discrete set of contiguous instructions 1734. Once the interruption is handled, the interruption handler executes a return from interrupt (“rfi”) instruction 1736 which restores the processor state to the state the processor was in when it was initially interrupted, and returns execution to the original flow of execution, as indicated by arrow 740 in FIG. 17A.

FIG. 17B is a flow-control diagram that describes the steps taken by the processor to dispatch an interruption. When the interruption occurs, the processor, in step 1742, stores the contents of the PSR and IP registers into the IPSR and IIP registers, stores the contents of the IP register at the time of execution of the last successfully executed instruction into the IIPA register, and updates additional interruption registers with new values reflective of the current interruption. In step 1744, the processor updates the ISR register with information related to the type of interruption that has occurred, which, along with the identity of the interruption vector to which instruction execution has been directed, identifies the specific type of interruption that has occurred. In step 1746, the processor updates the PSR register to place the processor into an interruption-handling state. As part of this update, the current priority level (“cpl”) field within the processor status register, PSR.cpl, is updated to have the value “0”, indicating the 0, or highest priority level. The Itanium processor handles all interruptions at the highest priority level. Next, in step 1748, the processor places the address of an interruption vector into the IP register and, in step 1710, resumes execution by executing the first instruction in the interruption vector corresponding to the interruption pointed to by the contents of the IP register.

The Itanium processor features parallel instruction execution and pipelined instruction execution. Pipelining instructions greatly speeds instruction execution. Pipelined execution of instructions is similar to assembly-line mass production in a factory, where a number of different products are concurrently assembled as they pass through various assembly stations. Rather than executing a single instruction at a time, the processor executes portions of multiple instructions in assembly-line-like fashion. However, when an interruption occurs, the pipeline is flushed and then restarted, resulting in the loss of between 20 and 40 instruction cycles. As new processors continue to incorporate ever increasing amounts of pipelining and instruction-execution parallelism, the deleterious effects of pipeline flushes are expected to increase.

In the Itanium architecture, a class of instructions is considered to comprise privileged instructions, and can only be executed by a routine running at priority level 0, the highest of the four priority levels supported by the Itanium architecture. Operating systems are meant to execute at priority level 0, and have exclusive access to privileged instruction and registers, and generally set protection-key fields within translation-lookaside-buffer entries that provide address translations for OS-specific portions of memory and devices so that that these OS-specific portions of memory and devices are accessible only at priority level 0. The priority level and privilege-based partitioning of machine resources enable an operating system to exercise exclusive control over resources and instructions that, if used by an application program, would allow the application program to interfere with execution of other application programs or the operating system. However, when a virtual machine monitor is interposed between the hardware/firmware layer and one or more guest operating systems, the virtual machine monitor needs to maintain exclusive control over those privileged machine resources and instructions normally controlled by an operating system. Otherwise, a guest operating system executing above a virtual machine monitor may execute instructions or access privileged registers that would allow the guest operating system to interfere with execution of other guest operating systems or the virtual machine monitor. Thus, a virtual machine monitor needs to execute at priority level 0, and prevent both guest operating systems and application programs executing within application-program-execution environments provided by the guest operating systems, from executing at priority level 0 and thus having access to privileged instructions and registers.

However, in general, the virtual machine monitor needs to provide to each guest operating system a virtual machine interface essentially identical to the hardware/firmware interface above which the virtual machine monitor is layered. Because guest operating systems generally assume access to priority level 0, and, by executing at priority level 0, access to privileged instructions and registers, the virtual machine monitor cannot simply compel guest operating systems to execute at lower priority levels. Instead, the virtual machine monitor provides an illusion to guest operating systems that they are, indeed, executing at priority level 0 by providing a virtual priority level 0 used by guest operating systems. However, in fact, the virtual priority level 0 is mapped by the virtual machine monitor to a priority level lower than priority level 0 or, in other words, numerically larger than priority level 0. By doing so, the virtual machine monitor can intercept any and all attempts by guest operating systems to execute privileged instructions or other instructions which require software virtualization assistance, and instead emulate execution of the privileged instructions, or execute the privileged instructions on behalf of the guest operating systems, in order to maintain exclusive control over privileged registers and privileged instructions and present a consistent view of the virtualized machine state.

The Itanium processor architecture provides one mechanism for avoiding interruptions when transitioning between application programs and operating systems running at the highest privilege level. FIG. 17C illustrates operation of the epc instruction. In FIG. 17C, an application program executes instructions 1752 within an application-program-priority-level page, with the thread of execution indicated, in FIG. 17C, by curved arrows, such as curved arrow 1754. At instruction 1756, the application program calls an operating system routine in order to avail itself of an operating system service. This call, or branch, results in transfer of control 1758 to a first instruction 1760 of a high-level priority virtual-memory page including the first instruction 1760. The first instruction is an epc instruction that promotes the current priority level, maintained in the PSR register, to a higher-priority priority level, and instructions following the epc instruction constitute operating-system-service-routine instructions that execute at priority level 0 and that therefore have full access to privileged instructions and privileged registers. The transition from application-program execution to operating-system execution, facilitated by the epc instruction, involves no interruptions, and therefore neither degrades the pipelining efficiency of the processor nor incurs the state-saving overhead of machine interruption handling.

FIG. 17D is a high-level flow-control diagram of the epc-instruction mechanism. In step 1762, a branch or call instruction is executed by a lower-priority-level routine in order to call a 0-priority-level operating system routine. In Step 1764, the Itanium processor saves the contents of the CFM and EC registers into fields within the PFS register, and saves the current machine priority level in a third field of the PFS register. Next, in step 1766, the machine begins execution of the epc instruction. First, in step 1768, the machine determines whether the previous machine priority level, currently stored in a field of the PFS register, is numerically less than the current machine priority level. If so, then an attempt has been made by the calling routine to emulate prior execution at a higher-priority priority level, so that the process may later be resumed at the higher-priority priority level, as stored in the PFS.ppl field, which is not allowed by the architecture. Therefore, in step 1760, a fault is generated. However, if the calling routine has successfully called a routine that executes at the same or a higher machine privilege level, then, in step 1762, the current machine priority level is set to the priority level of the virtual page containing the epc instruction, obtained from the translation-lookaside-buffer entry for that page. Finally, in step 1774, execution continues at the new priority level, generally the priority level 0, for execution of an operating system routine.

The Intel Itanium-2® architecture is currently under development, and adds a number of features to better support virtual-machine monitors. First, a new virtual-monitor (“vm”) bit has been added to the PSR. When the PSR.vm bit is cleared, the processor operates in a fashion similar to the original Intel Itanium processors. However, when the PSR.vm bit is set, all privileged instructions and certain non-privileged instructions, such as the thash instruction, that reveal processor or allow processor state to be indirectly modified by unprivileged execution threads, cause a new type of fault referred to as a “virtualization fault.” The PSR.vm bit is cleared on all interruptions delivered through the IVT, and can be reset when the VMM returns execution to a guest operating system via the rfi instruction. The Itanium-2 architecture provides for a new instruction, vmsw, that allows the PSR.vm bit to be set and cleared with minimum overhead. When the PSR.vm is set, only the lower half of the 64-bit virtual address base is accessible, while, when the PSR.vm bit is cleared, all 64 bits are accessible. Thus, one-half of the 64-bit virtual-address space is reserved for VMM access only. Several new vectors are added to the IVT to facilitate identification, by VMM interruption handlers, of both the cause of a virtualization fault and the faulting opcode. The PAL firmware layer is enhanced, in the Itanium-2 architecture, to provide a variety of VMM services and a virtual-processor-descriptor table (“VPD”). The new PAL services employ a new calling convention specifically designed for VMMs. The PAL services facilitate efficient guest-operating-system access to interruption-control registers and allows the VMM to enable and disable virtualization of particular resources and instructions.

In essence, the PSR.vm bit introduces a higher-level bifurcation of processor state, including privilege levels. Guest operating systems and higher-level computational entities can use the full range of privilege levels, from PL0 to PL3. However, even when executing at privilege-level PL0, guest operating systems and higher-level entities, with PSR.vm bit set to 1, cannot directly access privileged instructions and cannot access one-half of the 64-bit address base. Only an execution thread operating with PSR.vm cleared and executing at privilege level 0 can directly access privileged instructions.

### EMBODIMENTS OF THE PRESENT INVENTION

As discussed above, current virtual-machine monitors (“VMMs”) remain vulnerable to a wide variety of different security threats. VMMs, and the higher-level computational entities that they support, are vulnerable to attacks through I/O and network communications, insertion of malicious code into guest operating systems and application programs, and insecure use of memory and other hardware-level computational resources resulting from the massive complexity of the huge amount of code executing at highest privilege. For this reason, strategies for developing new, secure VMMs, as well as more secure VMMs, are needed by researchers and developers, manufacturers, and, ultimately, users of VMM-based computer systems.

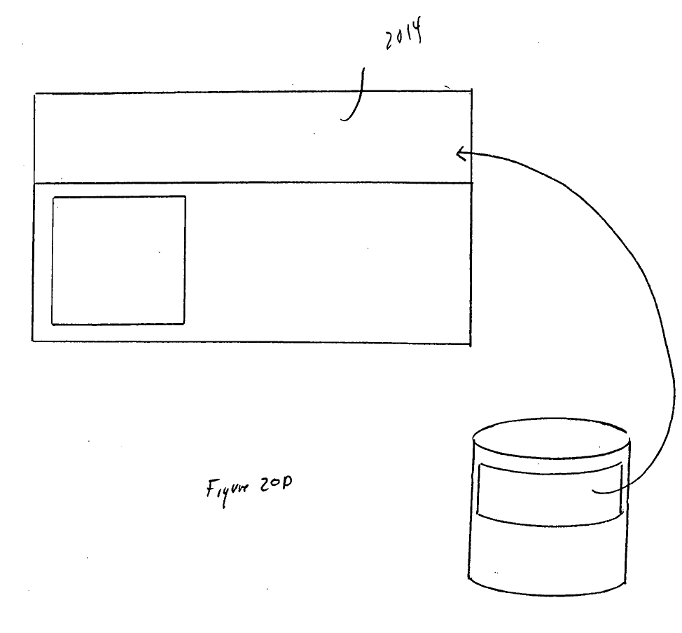

FIG. 18 shows a typical medieval castle. The medieval castle provides an exceedingly apt analogy for the design and development techniques that represent embodiments of the present invention.

The castle 1802 is designed primarily for security, namely securing life, limb, and treasure of a royal family. The castle employs a variety of different, hierarchically ordered security measures in order to secure the royal family. First, the castle is generally located in a favorable geographical location 1804, such as a hilltop. It is generally built well within the borders of a kingdom, where construction of the castle can be carried out safely and completed prior to attack by invading armies or rebellious peasants, and carried out without being observed by spies and neighboring-kingdom armies that might gain advantage from knowing construction details. It is also constructed in a defensible location, such as a hilltop, that affords natural, location-based security, such as downward sloping landforms on all sides, to hinder the approach of invading armies or mobs of rebellious peasants. The hillside also provides an optimal vantage point for surveillance and observation of the surrounding areas.

In general, the castle employs a many-tiered system of defenses. The castle may be surrounded by a moat 1806, a thick and very high wall 1808, and additional walls and obstacles within the interior space enclosed by the high wall that provide multiple redoubts for continuing defense of the royal family should the moat and outer castle walls be breached by invading armies or mobs of rebellious peasants. The castle also employs a very restricted number of access points. The moat is crossed by a single bridge 1810 that can be easily destroyed when the approach of an invading army or mob of rebellious peasants is observed. The castle wall 1808 generally has a single point of entry and exit 1812, protected by heavy doors. Similar limited access through fortified entry and exit points may be employed in inner fortifications within the castle. Moreover, parties seeking to enter the castle are identified and their entry authorized prior to opening of the doors of the castle. Finally, the castle is generally guarded by armed soldiers, including vigilant observers, or monitors, 1812 that survey the surrounding environment for signs and warnings of the approach of an invading army or riotous discontent within the peasantry in surrounding villages. In short, the castle is initially soundly and securely constructed and is protected by tiers of nested security measures and constant surveillance for threats in the surrounding environment.

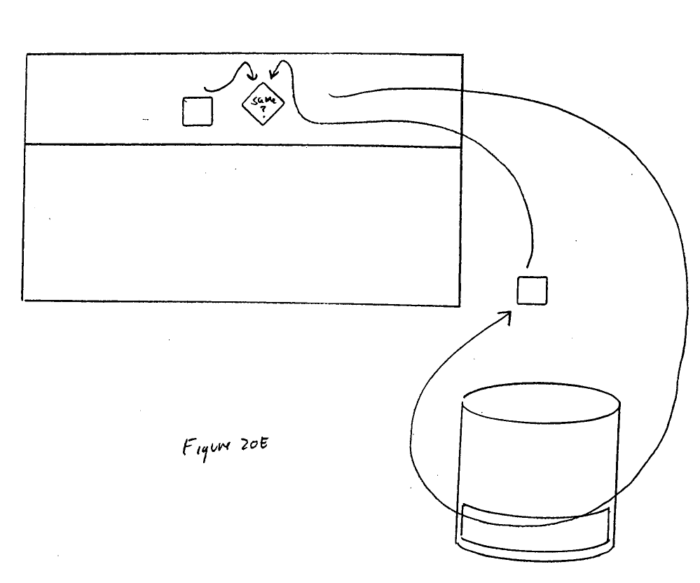

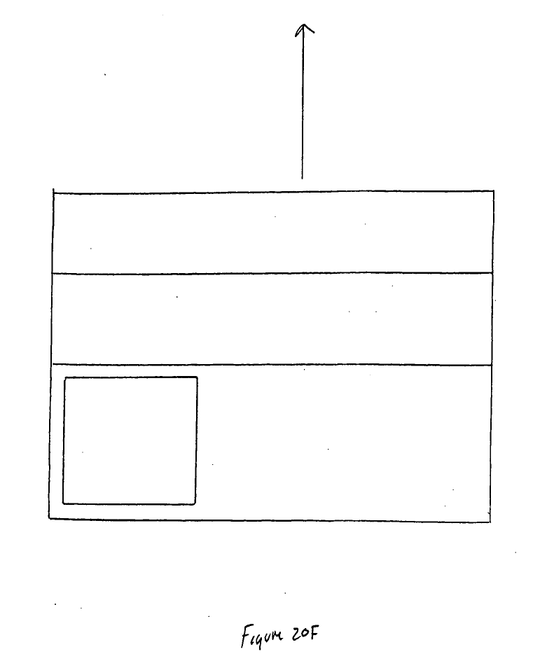

The security measures employed by the castle are similar in organization and strategy to those employed according to the present invention to create a secure VMM and guest-operating-system execution environment. FIG. 19 illustrates the overall strategy and architecture of a secure VMM and underlying secure foundation that represent embodiments of the present invention. The architecture of the present invention includes: (1) a secure foundation, a small portion of which executes at privilege level 0, and which execute with PSR.vm cleared. In other words, only a core portion of the secure foundation executes at highest possible privilege level 1902 directly above the hardware level 1904, and the remainder executes at PL1; (2) a secure VMM 1906 that executes at PL1 with PSR.vm cleared, and that includes one or more guest-operating-system monitors 1908, secure, VMM-accessible-only memory 1910, and I/O drivers 1912; (3) one or more guest operating systems 1914 that execute at PL0 with PSR.vm set; and (4) one or more application programs 1916 that execute at PL3 with PSR.vm set. Certain special application programs, such as DNS servers, accelerators, and self-protecting, defensive counter measures may be implemented to directly execute above the secure foundation 1902.

In general, the secure foundation 1902 supports the overlying VMM 1906 that provides an execution environment for one or more guest operating systems. Network I/O 1918 is input to the computer system through a secure network I/O stack implements as part of the secure foundation. This self-protecting network I/O stack acts as a sophisticated, internal firewall, constantly monitoring the incoming data for a variety of different threats and security breaches. The memory 1920 of the computer system 1900 is strictly compartmentalized, each compartment, such as compartment 1922, provided only the minimum access rights needed for proper operation of the computer system. The memory compartments may be strictly secured from entities other than the entity to which the memory compartments are allocated by use of access rights and protection keys. The memory compartments may be additionally protected by call-authentication techniques, represented by heavy lines 1924 and 1926 in FIG. 19, implemented and enforced within the secure foundation 1902, to ensure that only the entity to which the memory compartment has been allocated can access the memory compartment. Finally, data residing on internal and external mass-storage devices 1930 is automatically encrypted and integrity-protected by I/O drivers 1912 within the VMM on WRITE, and automatically decrypted and validated by the I/O drivers 1912 within the VMM on READ, to ensure that external entities cannot access computer-system data stored on mass-storage devices. Moreover, the encryption keys that allow data to be automatically encrypted and decrypted 1932 are stored in VMM-accessible-only memory compartments 1934, to prevent computational entities, external from the VMM, from accessing and using the cryptographic keys. Finally, the secure foundation, VMM, and higher-level entities are securely instantiated by a chain of trust 1936-1939. In essence, each component of the secure computer system must be verified prior to instantiation, to prevent inadvertent instantiation of compromised components.

The chain of trust 1936-1939 and highest-privilege-level secure foundation 1902 are analogous to favorable geographical placement and secure construction of the castle in the castle analogy drawn with reference to FIG. 18. The guest-operating-system monitor 1908 and the network I/O stack within the secure foundation 1902 are together analogous to the vigilant observers 1812 in the castle constantly monitoring the surrounding environment for potential security breaches. The compartmentalized memory 1920, caller authentication techniques 1924 and 1926, hierarchical ordering of the secure foundation, VMM, and the guest operating systems, with hierarchically ordered privileges, together present a tiered, hierarchical system of defenses with minimal, well-controlled points of entry and exit, as discussed with respect the castle analogy.

Many different features of the general architecture, described with reference to FIG. 19, contribute to the overall security of the guest-operating-system execution environment provided by the secure VMM and secure foundation. First, the secure foundation includes only a minimal amount of code that executes at privilege level PL0. The PL0 code is openly published for expert and peer review, comprises only mechanisms used for basic processor-state and machine-state control of the hardware level of the computer system through privileged instructions, and is sufficiently well-bounded and small to be fully and completely verified for secure operation.

A second feature of the system is that access rights and other privileges and services are distributed with maximum parsimony. Memory compartments, for example, are provided only the minimum access rights needed for correct operation of the entity to which the memory compartments are allocated. Executable instructions, for example, are stored in memory compartments with only execute access. Data that only needs to be read after loading is stored in memory compartments with only read-only access. Memory stacks and other data structures are never provided execute privileges. Therefore, it is impossible for data to be corrupted by external entities, and it is impossible for malicious executables to be inserted or injected into the system. Access rights may initially be promoted to load data into memory compartments, but is then immediately lowered to the minimum-needed access rights. Dynamic alteration of access rights is effected through protection keys, which can only be used to demote, but never to promote, the access rights specified in TLB entries.

Services and computational resources are also distributed with maximum parsimony. Each computational entity is allowed access only to a minimum number of VMM and secure-foundation services needed by the entity for correct operation. Secure-foundation services are provided only through the authenticated-call mechanism, so that only entities allocated services can access them. I/O drivers within the VMM use only virtual addresses, and cannot access or control the virtual-address-to-physical-address translations. All data stored on mass-storage devices is encrypted by encryption keys securely stored within virtual-memory-accessible-only memory compartments. All data input to the computer system, either through network communications or through I/O devices, is constantly monitored for potential security threats. Operations of the guest operating systems that execute above the VMM are constantly monitored by the guest-operating-system monitor or monitors within the VMM. These guest-operating-system monitors cannot be accessed or interfered with by computational entities above the VMM. Critical data structures used by guest operating systems may be securely stored in VMM-accessible-only memory compartments, and accessed by the guest operating systems through authenticated calls to VMM services. Thus, neither the guest operating systems nor higher-level computational entities can directly access and modify critical data structures.

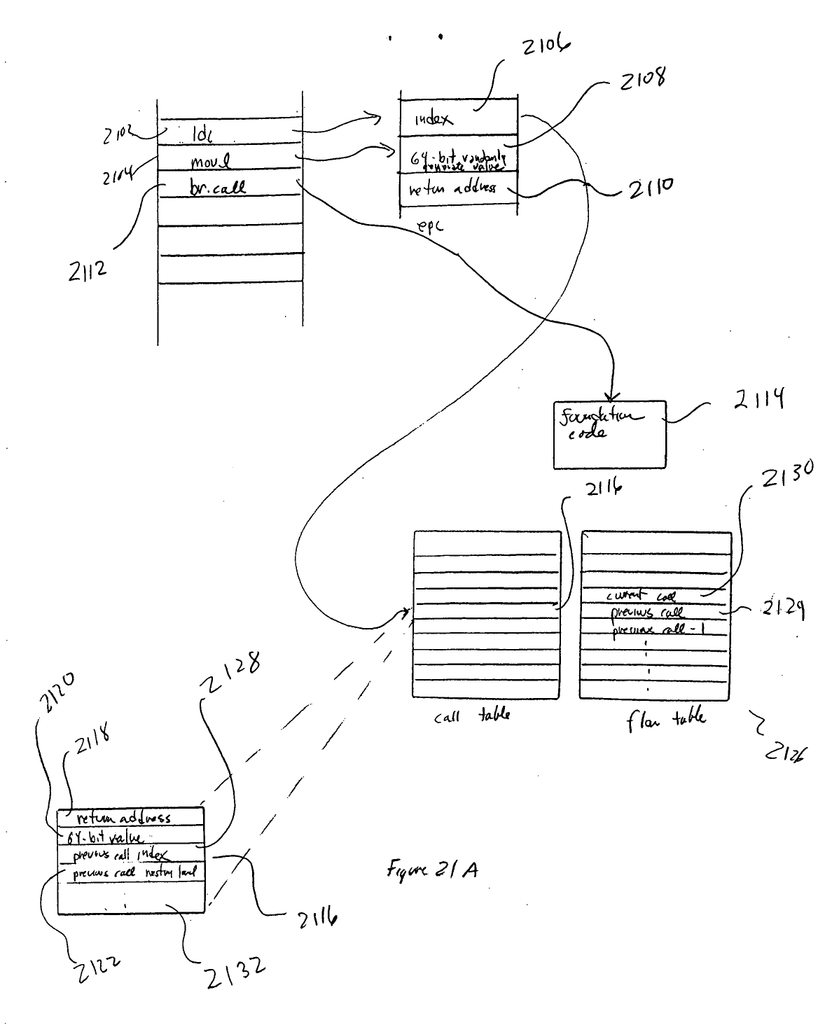

FIGS. 20A-F illustrate the chain of trust inherent in instantiation of components of a VMM-based computer system according to embodiments of the present invention. Initially, at power on, the processor 2002 or processors of the computer system compute a digital signature 2004 from the first firmware 2006 to be loaded in memory and executed by the processor. The initial firmware 2006 may be stored in flash memory or other types of read-only memory. The processor compares the computed digital signature 2004 to a digital signature 2008 stored securely at the hardware level accessible only to the processor. If the computed digital signature 2004 is identical to the stored digital signature 2008, then initial firmware 2006 is loaded and executed by the processor, as shown in FIG. 20B. The initial firmware, as shown in FIG. 20C, may then instantiate additional firmware stored on a mass-storage device or other data-storage component, such as option ROMs on I/O adapter boards. The initially executing firmware computes a digital signature 2010 from the second-level firmware and compares the computed digital signature to a digital signature 2012 stored within the initial firmware loaded by the processor, as shown in FIG. 20D, following verification and authentication of the initial firmware. If the computed digital signature 2010 is identical to the stored digital signature 2012, then, as shown in FIG. 20D, second-level firmware may be accessed and installed 2014 into the computer system. In similar fashion, as shown in FIGS. 20E and 20F, each additional firmware and software layer, up at least through all components of the VMM, and possibly extending to the guest operating systems and application programs that execute on the guest operating systems, can be verified prior to instantiation by the previously verified and instantiated layers and components. By this technique, a secure VMM-based computational environment can be instantiated and initialized securely, without threat of breach or attack as the hierarchically layered systems of defense are constructed. This process may be accompanied by compounding and storing measurements of each firmware and software phase in a security check, such as a TPM.

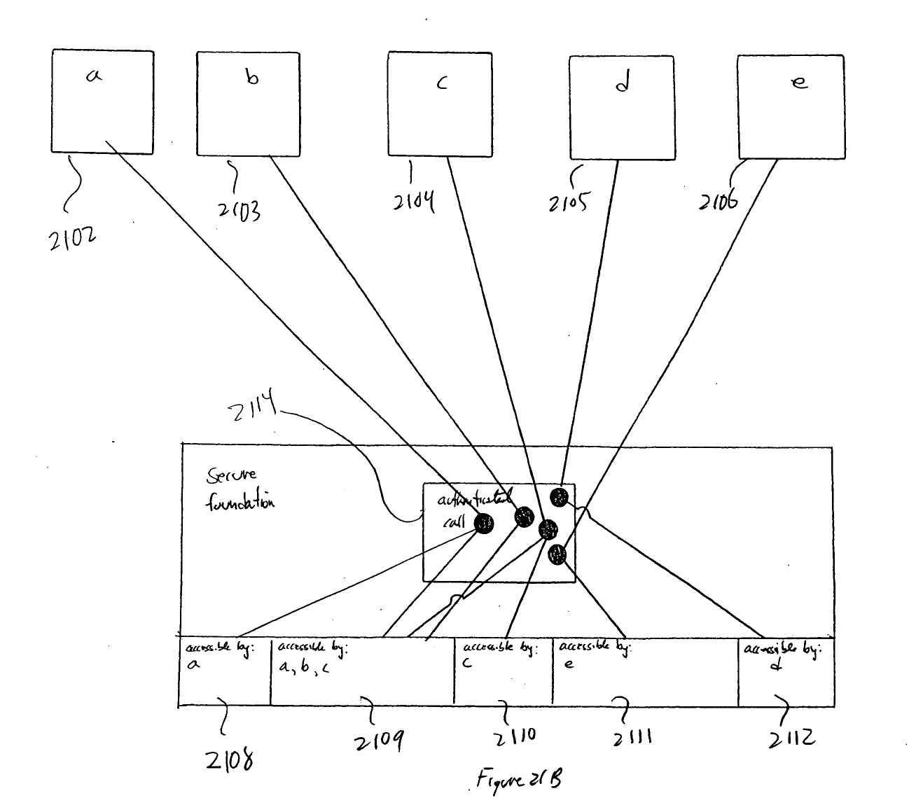

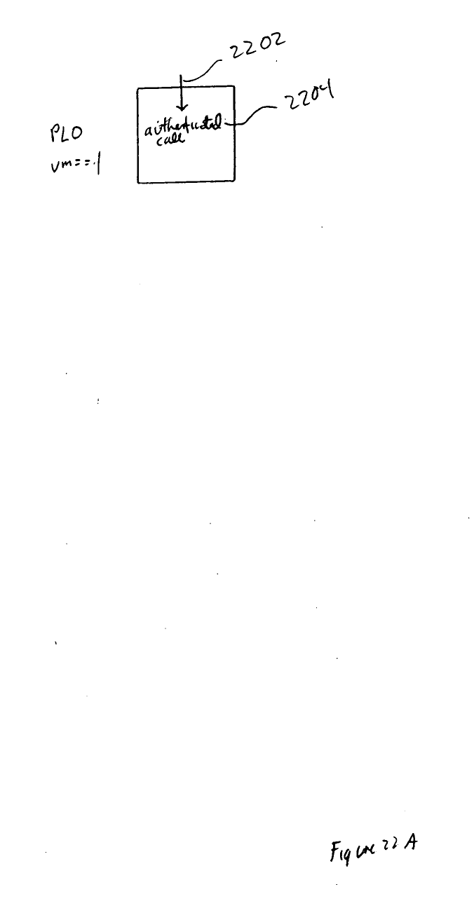

FIGS. 21A-B illustrate the call-authentication method used according to embodiments of the present invention to partition secure-foundation and VMM services among higher-level computing entities and to strictly control access to various computational resources, including VMM memory compartments that store critical data used by higher-level entities. As shown in FIG. 21A, guest-operating-system code includes macros for calling VMM and secure-foundation services. These macros insert instructions 2102 and 2104 into the calling sequence that load an index 2106 and a 64-bit randomly generated value 2108 that is generated by a secure loader into argument registers used for Itanium routine calls, along with the return address 2110 automatically inserted by Itanium processors into an argument register. A service is called by the guest-operating-system code 2112 via an epc instruction and epc page that results in execution of secure foundation code 2114 which, in part, implements the call-authentication mechanism. The call-authentication mechanism uses the index 2106 in the argument register to identify a corresponding entry 2116 in a call table. The call table is prepared during instantiation of the components of the VMM-based computer system. The call-authentication code then compares the return address 2110 with a return address 2118 within the call-table entry 216 and the 64-bit randomly generated value 2108 in the argument register with a 64-bit value 2120 stored in the call-table entry 2116. If the return address and 64-bit values in the argument registers match those in the call-table entries, the call-authentication routine then uses a previous-call-nesting level 2122 stored in the call-table entry 2116 to identify an index 2124 of a previously called routine stored in a flow table 2126, which acts like a stack of indexes that mirrors the current execution stack of the processor. If the index stored at the location 2124 in the flow table, identified by the previous-call-nesting level 2122 stored in the call entry 2116, matches an index 2128 stored within the call-table entry 2116, then the call-authentication routine is assured that the call 2112 from the guest operating system is valid, pushes the index 2106 of the calling routine onto the flow table 2130, and authorizes continued execution of the call. Otherwise, an error is returned to the calling routine.

Call authentication tightly controls access to secure-foundation and VMM services. Call-authentication provides a way of limiting secure-foundation services to specific higher-level computational entities. FIG. 21B illustrates partitioning of secure-foundation services among higher-level computational entities. In FIG. 21B, a number of higher-level computational entities 2102-2106 access a number of secure-foundation services 2108-2112 via the authenticated-call mechanism 2114 described above with reference to FIG. 21A. The authenticated-call mechanism 2114 can be used to ensure that service 2108 is accessible only by computational entity a 2102, service 2109 is accessible only by computational entities a, b, and c, service 2110 is accessible only by computational entity c, service 2111 is accessible only by computational entity e, and service 2112 is accessible only by computational entity d. Only those computational entities to which particular services are allocated at system-instantiation time can access those services. Thus, call authentication provides strict access control for all privileged services based on execution of the privileged instructions. The call-table entry 2116 in FIG. 21A may additionally contain protection keys 2132 needed by the calling entity in order to access memory compartments allocated to the calling entity. The call-authentication routine can load the protection keys included in the call-table entry 2116 in order to enable access by the calling entity to memory compartments allocated to the calling entity. Upon completion of the call, a call-authentication routine may be invoked to pop the index 2130 from the flow table and remove the protection keys from the protection-key registers in order to disable the memory compartment, preventing access to the memory compartment by subsequently executing routines. Although, in the previous discussion, guest-operating-system routines are shown as directly accessing secure-foundation services, they may often indirectly access a secure-foundation service via an initial call to the VMM, which then makes a second authenticated call to the secure foundation service.

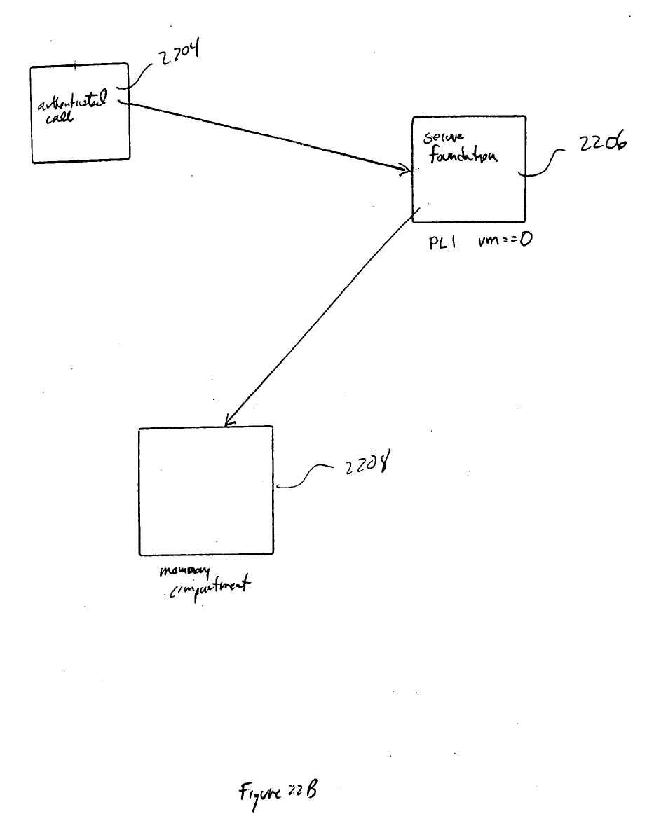

FIGS. 22A-C illustrate, in an alternative fashion, control of memory compartments via the authenticated-call mechanism. In FIG. 22A, a guest-operating system is executing 2202 at PL0 and with PSR.vm set, prior to making an authenticated call 2204. As shown in FIG. 22B, when the authenticated call 2204 is successfully made by the guest-operating-system routine, secure-foundation code executes at PL0 with PSR.vm cleared. Once authenticated, the call may invoke a VMM routine or service that is additionally authenticated by call authentication. This allows access to VMM-accessible-only memory by the VMM and to privileged service that effect state changes. In addition, loading of the protection keys included in the call-table entry during the authenticated call enables a memory compartment 2208 to be accessed on behalf of the guest operating system. When the call completes, as shown in FIG. 22C, the memory compartment is no longer accessible, and the privilege level is restored to PL0 with PSR.vm set. Thus, only during the authenticated call is the memory compartment 2208 briefly opened to allow access to secure data by the VMM.

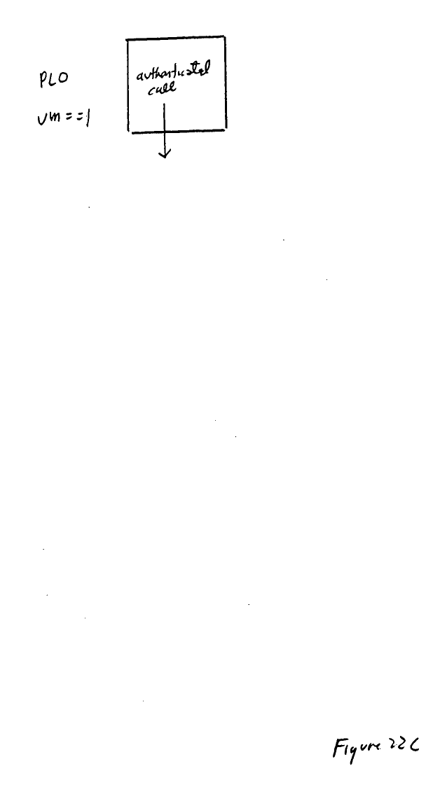

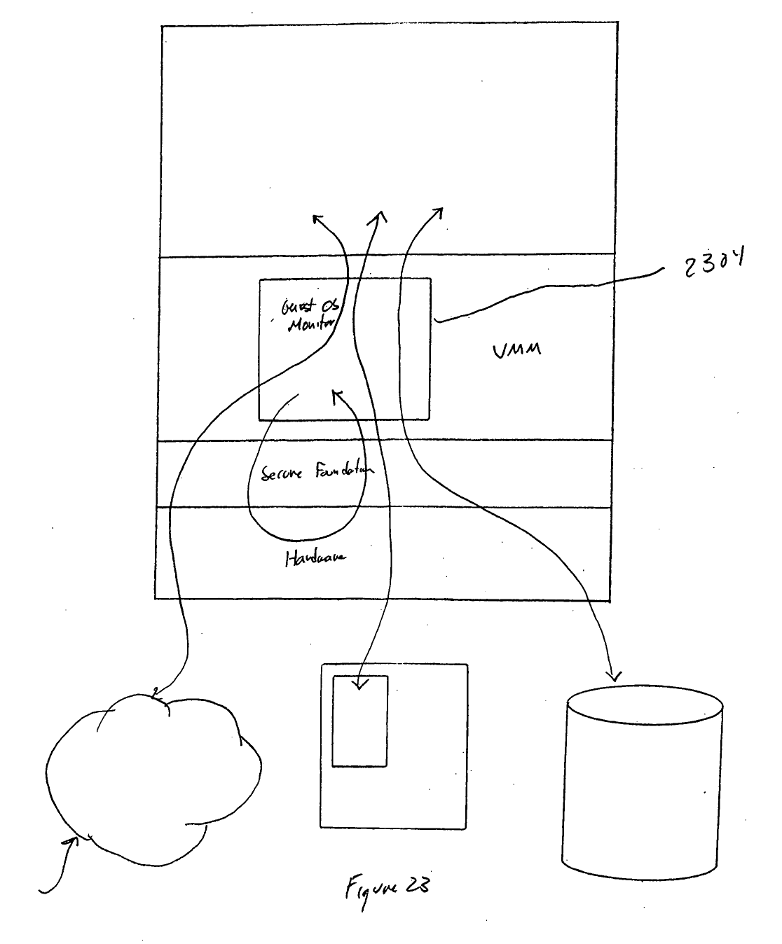

FIG. 23 illustrates one fundamental feature of VMMs that represent embodiments of the present invention. As shown in FIG. 23, the VMM can include a fully embedded guest-operating-system monitor 2304 that can initially verify that the instantiated guest-operating-system code is correct and uncorrupted, and can then continuously monitor data input to, and output from, the guest operating system for any signs or indications of potential security threats or invalid state transitions of the guest operating system. The guest-operating-system monitor 2304 is fully contained within the VMM, and cannot therefore be accessed, observed, corrupted, or otherwise affected by computational entities outside of the VMM and secure foundation. A guest-operating-system monitor can thus be implemented to close many of the security holes that are unavoidably existent within guest operating systems.

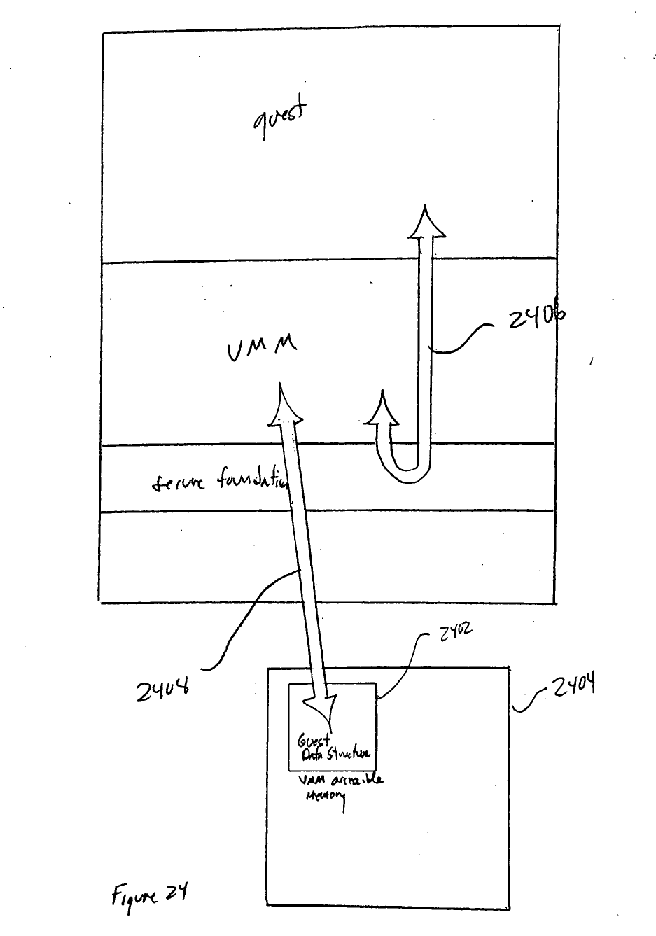

FIG. 24 illustrates another fundamental feature of virtual-machine monitors that represent embodiments of the present invention. A serious problem in current VMM-based computer systems is that critical data structures used by guest operating systems cannot be fully protected from the guest operating systems and other computational entities. However, the VMM environments provided by the present invention provide fully secure storage and management of critical data structures on behalf of guest operating systems. The guest-operating-system critical data structures 2402 are stored in a VMM-accessible-only memory compartment 2404. In order to access the critical data structure 2402, the guest operating system must first make an authenticated call to a VMM service 2406. The VMM service can then make an authenticated call 2408 to the secure foundation to access the guest-operating-system critical data structure 2402 on behalf of the guest operating system. The guest operating system cannot directly access the critical data structures, but can read from, and write to, the critical data structures only through a VMM service. The VMM can thus guarantee that these critical data structures are only correctly accessed from well-known and authorized points in the guest operating system. There is no mechanism by which a malicious entity or erroneous thread can access or alter the critical data structures.

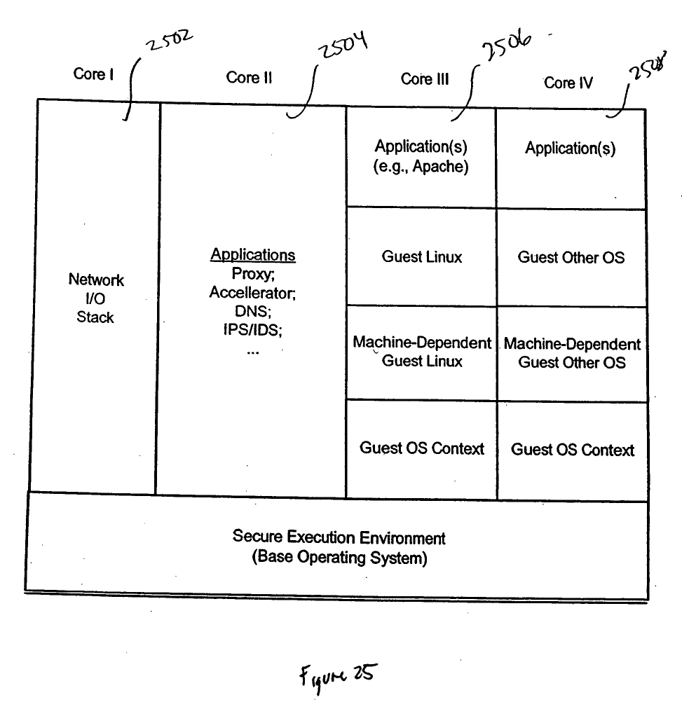

FIG. 25 illustrates partitioning of computational tasks of a VMM-based computer system among cores of a multi-core processor. As shown in FIG. 25, one core can be devoted entirely to the secure-foundation network I/O stack 2502, a second core 2504 can be devoted to application execution, and two additional cores 2506 and 2508 can be devoted to VMM-based execution of guest operating systems and application programs executing above the guest operating systems. The availability of multi-core processors allows for the efficient execution of guest operating systems and application programs along with concurrent surveillance and firewall-like monitoring by the secure-foundation network I/O stack as well as with special applications, directly interfacing to the secure foundation, that require large processing bandwidths and computational overheads.

Implementation of VMMs according to the present invention involves many additional considerations and features. For example, virtual memory may be allocated much differently than in traditional operating systems. Varying sized allocation units may be used in order to minimize the number of TLB entries needed at any given time by executing processes, in turn minimizing the number of TLB misses that occur during execution of a thread. Applications may be designed to be recoverable. Because of the strict compartmentalization of memory, when errors occur, when the application programs provide an entry point for identification upon faulting, the VMM-based computer system can reinitialize application data and resume the application efficiently. The call-authentication methods employed in VMMs of the present invention is extremely efficient, adding very little computational overhead to guest-operating-system and VMM execution.

Although the present invention has been described in terms of particular embodiments, it is not intended that the invention be limited to these embodiments. Modifications within the spirit of the invention will be apparent to those skilled in the art. For example, an essentially number of different VMMs and secure foundations can be implemented according to the present invention using different modular organizations, control structures, data structures, programming languages, and by varying other such programming and implementation characteristics and parameters. While the above discussion focuses on a number of valuable features provided by the present invention, many additional features and implementation details will characterize any particular implementation of a VMM and secure foundation according to methods of the present invention. While the Itanium-2 processor architecture is especially suited for implementing VMMs according to the present invention, future processor architectures will undoubtedly provide adequate platforms for implementing VMMs according to the present invention.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A secure virtual-machine-monitor-based computer system comprising:
a hardware platform;
a secure foundation that interfaces to the privileged-instruction interface of the hardware platform and that provides a secure-foundation services interface and call authentication to a virtual-machine monitor;
a virtual-machine monitor that interfaces to the secure foundation and that provides a virtual-machine interface to one or more guest operating systems, the virtual-machine monitor containing one or more guest-operating-system monitors and storing and managing critical guest-operating-system data in one or more memory compartments accessible only to the virtual-machine monitor; and
one or more guest operating systems that interface to the virtual-machine monitor.

2. The secure virtual-machine-monitor-based computer system of claim 1 wherein a portion of the secure foundation that interfaces to processor-state-altering privileged instructions executes at highest privilege level.

3. The secure virtual-machine-monitor-based computer system of claim 2 wherein the virtual-machine-monitor-based computer system is based on a modern processing architecture in which the highest privilege level is a combination of a processor-status-register-specified privilege level PL0 and a processor-status-register-specified virtual-monitor mode.

4. The secure virtual-machine-monitor-based computer system of claim 1 wherein the secure foundation implements a network I/O stack and other basic operating-system services that execute at an intermediate, virtual-monitor-mode priority level.

5. The secure virtual-machine-monitor-based computer system of claim 4 wherein the virtual-machine-monitor-based computer system is based on a modern processing architecture in which the intermediate, virtual-monitor-mode priority level is a combination of a processor-status-register-specified privilege level PL1 and a processor-status-register-specified virtual-monitor mode.

6. The secure virtual-machine-monitor-based computer system of claim 1 wherein the virtual-machine monitor executes at an intermediate, virtual-monitor-mode priority level.

7. The secure virtual-machine-monitor-based computer system of claim 6 wherein the virtual-machine-monitor-based computer system is based on a modern processing architecture in which the intermediate, virtual-monitor-mode priority level is a combination of a processor-status-register-specified privilege level PL1 and a processor-status-register-specified virtual-monitor mode.

8. The secure virtual-machine-monitor-based computer system of claim 1 wherein the one or more guest operating systems execute at a highest priority level available to non-virtual-monitor mode processes and threads.

9. The secure virtual-machine-monitor-based computer system of claim 6 wherein the virtual-machine-monitor-based computer system is based on a modern processing architecture in which the highest priority level available to non-virtual-monitor mode processes and threads is a combination of a processor-status-register-specified privilege level PL0 and a processor-status-register-specified non-virtual-monitor mode.

10. The secure virtual-machine-monitor based computer system of claim 1 wherein memory compartments are established by protection keys and TLB-entry specified access rights.

11. The secure virtual-machine-monitor based computer system of claim 1 wherein call authentication involves modification of guest-operating system code by a secure loader to supply loader-generated secret information to secure-foundation call-authentication routine or routines that allow the secure-foundation call-authentication routine or routines to verify that the call is authorized to be made at the current execution location within the guest operating system and that that the call occurs within a proper sequence of routine calls.

12. The secure virtual-machine-monitor based computer system of claim 1 wherein the virtual-machine monitor automatically encrypts all data written to mass storage and decrypts all encrypted data read from mass storage by using encryption keys securely stored in one or more memory compartments accessible only to the virtual-memory monitor.
